(19) United States
(12) Patent Application Publication
(10) Pub. No.: US 2020/0187020 A1
(43) Pub. Date: Jun. 11, 2020

(54) IN-FACILITY TRANSMISSION SYSTEM, IN-FACILITY TRANSMISSION METHOD, AND BASE STATION

(71) Applicant: PANASONIC INTELLECTUAL PROPERTY MANAGEMENT CO., LTD., Osaka (JP)

(72) Inventors: Hiroaki ASANO, Kanagawa (JP); Hideki KANEMOTO, Kanagawa (JP); Osamu KATO, Fukuoka (JP)

(73) Assignee: PANASONIC INTELLECTUAL PROPERTY MANAGEMENT CO., LTD., Osaka (JP)

(21) Appl. No.: 16/615,646

(22) PCT Filed: Jan. 29, 2018
(86) PCT No.: PCT/JP2018/002748

§ 371 Date: Nov. 21, 2019

(30) Foreign Application Priority Data
May 30, 2017 (JP) 2017-107171

(51) Int. Cl. H04W 16/32; H04W 4/33

(52) U.S. Cl. CPC H04W 16/32; H04W 84/045; H04W 4/33

(57) ABSTRACT

Desired communication quality in relay for data transmission is secured, and stable radio communication is realized. An in-facility transmission system is disposed in a facility with a plurality of closed spaces, and includes a master base station that is disposed in a first closed space and performs a radio communication with an external base station provided outside the facility and a first slave base station that is disposed in a second closed space different from the first closed space and performs a radio communication with the master base station. The first closed space and the second closed space are connected to each other through a first radio waveguide capable of reducing a propagation loss of a radio wave in the radio communication between the master base station and the first slave base station.

### TECHNICAL FIELD

The present disclosure relates to an in-facility transmission system and an in-facility transmission method for performing data transmission by radio communication between a plurality of base stations in a facility, and to a base station used in the in-facility transmission system.

### BACKGROUND ART

In order to transmit large data by radio communication, a high frequency band (for example, using a high super high frequency (SHF) band of 6 to 30 GHz or an extremely high frequency band (EHF) of 30 to 300 GHz is examined, for example, in a 5G (fifth generation mobile communication system) radio network. In such a high frequency band, a radio wave propagation loss by a blocking object such as an obstacle is large. Assuming a high-frequency radio communication in a facility such as a house or a building, it may be difficult to perform radio communication with favorable communication quality in the facility. In the 5G radio network, it is also examined to incorporate an area securing technology of radio communication by radio multi-hop into the known cellular network.

For example, PTL 1 discloses a radio communication system in which a transceiver configured to perform relay between a base station installed in a private house and a mobile terminal is installed in each room in the private house in order to manage the position of the mobile terminal.

PTL 2 discloses a radio communication system in which each radio base station is disposed at the entrance, the corridor, and rooms in a building. In this radio communication system, in a case where a user moves with a terminal station in order of the entrance, the corridor, and a room in a building, the terminal station communicates with each radio communication station in order of the entrance, the corridor, and the room, and thus the radio base stations of the entrance and the corridor are grouped, and the radio base stations of the corridor and the room are grouped. Thus, it is possible to control an operation state of the radio base station according to the movement of the terminal station.

### CITATION LIST

### Patent Literature

PTL 1: Japanese Patent No. 5442484

PTL 2: Japanese Patent Unexamined Publication No. 2016-5099

### SUMMARY OF THE INVENTION

Here, a case of performing data transmission by performing relay between a plurality of base stations by high⁻frequency radio communication in a facility with a plurality of closed spaces partitioned by walls, ceilings, and the like is assumed.

As described above, in a high frequency band which using in, for example, a 5G radio network is examined, a loss when a radio wave passes through a blocking object is large, and a loss when a radio wave propagates from a closed space (for example, room) surrounded by blocking objects into another closed space (for example, another room) is large. Therefore, the power of a signal when the signal passes through a blocking object in a propagation path is largely reduced, and communication quality (for example, throughput and packet error rate) is largely deteriorated. Therefore, there are problems in that it may or may not possible to secure desired communication quality in a propagation path between base stations provided in different closed spaces, and it may be difficult to form a relay link (that is, radio communication link) for data transmission. Even in PTLs 1 and 2 described above, technical measures for solving the problems in relay between base stations with such a high frequency band are not considered yet.

The disclosure has been made in view of the above-described circumstances in the related art. An object of the disclosure is to provide an in-facility transmission system, an in-facility transmission method, and a base station in which it is possible to secure desired communication quality in relay for data transmission between base stations and to realize stable radio communication, in a facility in which the base stations are provided in different closed spaces.

The disclosure provides an in-facility transmission system disposed in a facility with a plurality of closed spaces. The in-facility transmission system includes a master base station that is disposed in a first closed space and performs a radio communication with an external base station provided outside the facility, and a first slave base station that is disposed in a second closed space different from the first closed space and performs a radio communication with the master base station. The first closed space and the second closed space are connected through a first radio waveguide capable of reducing a propagation loss of a radio wave in the radio communication between the master base station and the first slave base station.

The disclosure provides an in-facility transmission method using an in-facility transmission system disposed in a facility with a plurality of closed spaces. The in-facility transmission method includes a step of performing a radio communication with an external base station provided outside the facility, by a master base station disposed in a first closed space, and a step of performing a radio communication with the master base station by a first slave base station disposed in a second closed space different from the first closed space. The first closed space and the second closed space are connected through a first radio waveguide capable of reducing a propagation loss of a radio wave in the radio communication between the master base station and the first slave base station.

The disclosure provides a base station used in an in-facility transmission system disposed in a facility with a plurality of closed spaces. The base station is disposed in a first closed space among the plurality of closed spaces, and includes a first communicator that performs a radio communication with an external base station provided outside the facility and a second communicator that performs a radio communication with a slave base station disposed in a second closed space different from the first closed space in which the own station is disposed. The first closed space and the second closed space are connected to each other through a radio waveguide capable of reducing a propagation loss of a radio wave in the radio communication between the own station and the slave base station.

The disclosure provides a base station used in an in-facility transmission system disposed in a facility with a plurality of closed spaces. The base station is disposed in a first closed space among the plurality of closed spaces, and includes a communicator that performs a radio communication with a master base station provided in a second closed space different from the first closed space in which the own station is disposed. The first closed space and the second closed space are connected to each other through a radio waveguide capable of reducing a propagation loss of a radio wave in the radio communication between the own station and the master base station.

The disclosure provides a base station used in an in-facility transmission system which has a plurality of closed spaces and is disposed in a facility in which the plurality of closed spaces are connected to each other in radio through a radio waveguide. The base station is disposed in one closed space among the plurality of closed spaces and includes a first communicator that performs a radio communication with a master base station or a slave base station disposed in a closed space located upstream of the closed space in which the own station is disposed, in the radio connection through the radio waveguide, a second communicator that performs a radio communication with a slave base station disposed in a closed space located downstream of the closed space in which the own station is disposed, and a terminal acceptor that receives transmission data transmitted from a terminal connected to the own station. The transmission data received by the terminal acceptor and transmission data received by the second communicator are transmitted to the master base station or the slave base station through the first communicator.

The disclosure provides a base station used in an in-facility transmission system which has a plurality of closed spaces and is disposed in a facility in which the plurality of closed spaces are connected to each other in radio through a radio waveguide. The base station is disposed in one closed space among the plurality of closed spaces and includes a first communicator that performs a radio communication with a master base station or a slave base station disposed in a closed space located upstream of the closed space in which the own station is disposed, in the radio connection through the radio waveguide, a second communicator that performs a radio communication with a slave base station disposed in a closed space located downstream of the closed space in which the own station is disposed, and a terminal acceptor which is connected to at least one terminal. Transmission data received by the first communicator is transmitted to the slave base station through the second communicator and is transmitted to the terminal through the terminal acceptor.

According to the disclosure, it is possible to secure desired communication quality in relay for data transmission between base stations and to realize stable radio communication, in a facility in which the base stations are provided in different closed spaces.

### BRIEF DESCRIPTION OF DRAWINGS

FIG. 1 is a diagram illustrating an example of a specific system configuration in which an in-facility transmission system according to Exemplary Embodiment 1 is disposed in a private house.

FIG. 2A is a block diagram illustrating a configuration example of a master base station in Exemplary Embodiment 1.

FIG. 2B is a block diagram illustrating a configuration example of a slave base station in Exemplary Embodiment 1.

FIG. 3 is a schematic diagram illustrating an example of a logical tree in Exemplary Embodiment 1.

FIG. 4A is a sequence diagram specifically illustrating an example of an operation procedure when data transmission is performed between the master base station and three slave base stations in Exemplary Embodiment 1.

FIG. 4B is a sequence diagram specifically illustrating another example of the operation procedure when data transmission is performed between the master base station and the three slave base stations in Exemplary Embodiment 1.

FIG. 5 is a diagram illustrating an example of a specific system configuration in which an in-facility transmission system according to Exemplary Embodiment 2 is disposed in a private house.

FIG. 6A is a block diagram illustrating a configuration example of a master base station in Exemplary Embodiment 2.

FIG. 6B is a block diagram illustrating a first configuration example of a slave base station in Exemplary Embodiment 2.

FIG. 6C is a block diagram illustrating a second configuration example of the slave base station in Exemplary Embodiment 2.

FIG. 7 is a schematic diagram illustrating an example of a logical tree in Exemplary Embodiment 2.

FIG. 8 is a sequence diagram specifically illustrating an example of an operation procedure when data transmission is performed between the master base station and three slave base stations in Exemplary Embodiment 2.

FIG. 9 is a diagram illustrating an example of a specific system configuration in which an in-facility transmission system according to Exemplary Embodiment 3 is disposed in a private house.

FIG. 10 is a diagram illustrating a case where a problem occurs in a slave base station disposed in a room on a second floor.

FIG. 11 is a diagram illustrating an example of a transition of a logical tree caused by the occurrence of the problem in the slave base station.

FIG. 12 is a sequence diagram specifically illustrating an example of an operation procedure when data transmission is performed between the master base station and five slave base stations in Exemplary Embodiment 3.

FIG. 13 is a sequence diagram following FIG. 12.

### DESCRIPTION OF EMBODIMENTS

Hereinafter, exemplary embodiments of specifically disclosing an in-facility transmission system, an in-facility transmission method, and a base station according to the disclosure will be described in detail with reference to the drawings as appropriate. A more detailed description than necessary may be omitted. For example, detailed descriptions of already well-known matters and repeated descriptions for substantially the same component may be omitted. This is to avoid that the following descriptions become unnecessarily redundant and to facilitate understanding of those skilled in the art. The accompanying drawings and the following descriptions are provided to enable those skilled in the art to fully understand the disclosure, and are not intended to limit the subjects in the claims thereby.

As an example of a facility in which an in-facility transmission system according to the following exemplary embodiments is disposed, a private house in which a user of the in-facility transmission system resides will be described. The facility is not limited to the private house and may be a commercial facility such as a shopping mall or an office building, or a multiple dwelling house such as an apartment or a condominium.

### Exemplary Embodiment 1

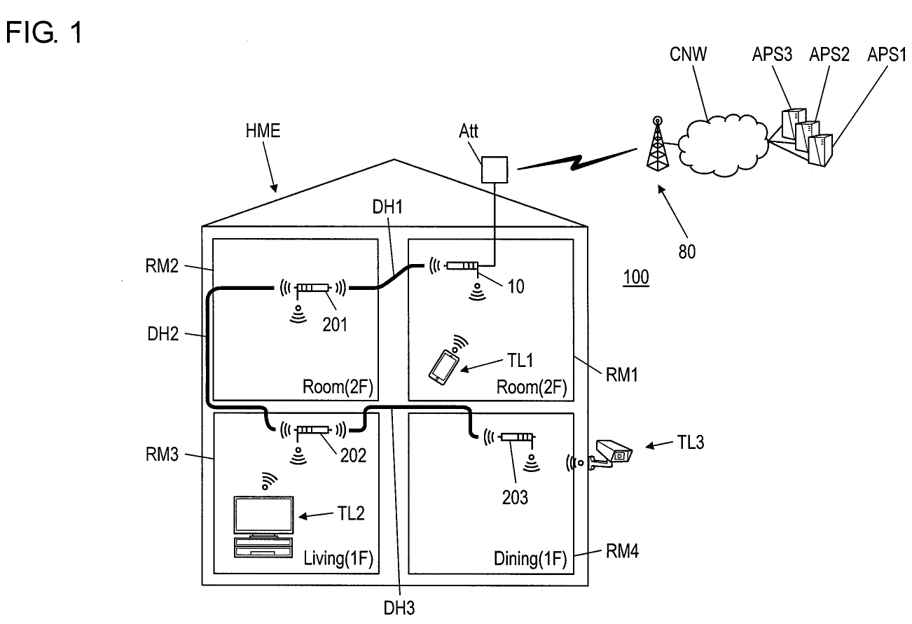

FIG. 1 is a diagram illustrating an example of a specific system configuration in which in-facility transmission system 100 according to Exemplary Embodiment 1 is disposed in private house HME.

In-facility transmission system 100 in Exemplary Embodiment 1 includes master base station 10 connected to antenna Att, first slave base station 201, second slave base station 202, third slave base station 203, external base station 80, and application servers APS1, APS2, and APS3. The in-facility transmission system in the following exemplary embodiments is assumed to be incorporated into the known cellular network system.

Private house HME illustrated in FIG. 1 is, for example, a two-floor residence and has a plurality of closed spaces. Private house HME may be a three-floor residence as in Exemplary Embodiment 3 described later, and may be a residence of floors more than the three floors. For example, the closed space is provided to be distinguishable from another closed space by a blocking object such as a ceiling surface or a wall surface. For example, living room RM3 and dining room RM4 are provided on the first floor, and rooms RM1 and RM2 are provided on the second floor.

In private house HME, base stations different from each other are disposed in the four closed spaces. Specifically, master base station 10 is disposed in a first closed space (for example, room RM1 on the second floor), and slave base station (example of a first slave base station) 201 is disposed in a second closed space (for example, room RM2 on the second floor). Slave base station (example of a second slave base station) 202 is disposed in a third closed space (for example, living room RM3 on the first floor). Slave base station (example of a third slave base station) 203 is disposed in a fourth closed space (for example, dining room RM4 on the first floor).

Room RM1 and room RM2 are connected to each other through dielectric waveguide DH1 as an example of a first radio waveguide. Dielectric waveguide DH1 has, for example, a tubular shape and is configured using a member capable of reducing a propagation loss of a radio wave in a radio communication in a high frequency band (for example, high SHF band of 6 to 30 GHz or EHF band of 30 to 300 GHz. The same applies the followings) of which using in 5G is examined. Thus, even though master base station 10 and slave base station 201 use the above-described high frequency band, it is possible to reduce a propagation loss of a radio wave when the master base station and the slave base station perform a radio communication with each other across a blocking object such as the ceiling surface or the wall surface of each of rooms RM1 and RM2. Accordingly, the master base station and the slave base station perform a favorable and stable radio communication with each other.

Room RM2 and living room RM3 are connected through dielectric waveguide DH2 as an example of a second radio waveguide. Similar to dielectric waveguide DH1, dielectric waveguide DH2 has a tubular shape and is configured using a member capable of reducing a propagation loss of a radio wave in a radio communication in a high frequency band (see the above description) of which using in 5G is examined. Thus, even though slave base station 201 and slave base station 202 use the above-described high frequency band, it is possible to reduce a propagation loss of a radio wave when slave base station 201 and slave base station 202 perform a radio communication with each other across a blocking object such as the ceiling surface or the wall surface of each of room RM2 and living room RM3. Accordingly, slave base station 201 and slave base station 202 perform a favorable and stable radio communication with each other.

Living room RM3 and dining room RM4 are connected to each other through dielectric waveguide DH3 as an example of a third radio waveguide. Similar to dielectric waveguide DH1, dielectric waveguide DH3 has a tubular shape and is configured using a member capable of reducing a propagation loss of a radio wave in a radio communication in a high frequency band (see the above description) of which using in 5G is examined. Thus, even though slave base station 202 and slave base station 203 use the above-described high frequency band, it is possible to reduce a propagation loss of a radio wave when slave base station 202 and slave base station 203 perform a radio communication with each other across a blocking object such as the ceiling surface or the wall surface of each of living room RM3 and dining room RM4. Accordingly, slave base station 202 and slave base station 203 perform a favorable and stable radio communication with each other.

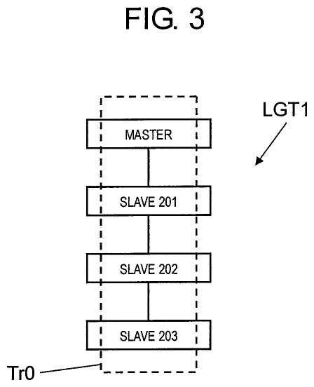

Thus, master base station 10, slave base station 201, slave base station 202, and slave base station 203 are connected to each other through dielectric waveguides DH1, DH2, and DH3 in a one-stroke manner. That is, master base station 10 can be considered as a base station on the most upstream, slave base station 201 can be considered as a base station located downstream of master base station 10, slave base station 202 can be considered as a base station located downstream of slave base station 201, and slave base station 203 can be considered as a base station on the most downstream (see FIG. 3). Accordingly, master base station 10, slave base station 201, slave base station 202, and slave base station 203 can perform multi-hop radio communication with each other.

Here, each base station (master base station 10 and slave base stations 201, 202, and 203) will be described.

Master base station 10 forms an access link for a radio communication with at least one terminal (for example, administrator terminal TL1 such as a smartphone) in room RM1 or a communication area with master base station 10 and functions as a base station in a radio communication with administrator terminal TL1. Here, the terminal may be a general terminal (that is, terminal used by a general user other than an administrator) having a communication function (not illustrated), instead of administrator terminal TL1. Master base station 10 receives and accepts transmission data transmitted from, for example, administrator terminal TL1, or transmits transmission data held by the own station (that is, master base station 10) to administrator terminal TL1.

Master base station 10 performs a radio communication with external base station 80 provided outside private house HME, through antenna Att.

Master base station 10 forms a backhaul link for a radio communication with slave base station 201 to transmit (relay) transmission data (see the descriptions made later) held by master base station 10 to external base station 80 or slave base station 201, or to receive transmission data transmitted (relayed) from external base station 80 or slave base station 201. The transmission data held by master base station 10 is not limited to just transmission data accepted from administrator terminal TL1 by master base station 10 and may further include transmission data transmitted (relayed) from slave base station 201 by multi-hop. The transmission data held by master base station 10 may be transmission data which has been transmitted from external base station 80 and received by antenna Att.

Slave base station 201 forms an access link for a radio communication with at least one terminal (not illustrated) in room RM2 or a communication area with slave base station 201 and functions as a base station in a radio communication with this terminal. Slave base station 201 receives and accepts transmission data transmitted from, for example, the above terminal, or transmits transmission data held by the own station (that is, slave base station 201) to the above terminal.

Slave base station 201 forms a backhaul link for a radio communication with master base station 10 or with slave base station 202 to transmit (relay) transmission data (see the descriptions made later) held by slave base station 201 to master base station 10 or slave base station 202, or to receive transmission data transmitted (relayed) from master base station 10 or slave base station 202. The transmission data held by slave base station 201 is not limited to just transmission data accepted by slave base station 201 from at least one terminal (not illustrated) in room RM2 or a communication area with slave base station 201. This transmission data may further include transmission data transmitted (relayed) from master base station 10 or slave base station 202 by multi-hop.

Slave base station 202 forms an access link for a radio communication with at least one terminal (for example, recorder TL2) in living room RM3 or a communication area with slave base station 202 and functions as a base station in a radio communication with recorder TL2. Slave base station 202 receives and accepts transmission data transmitted from, for example, recorder TL2, or transmits transmission data held by the own station (that is, slave base station 202) to recorder TL2.

Slave base station 202 forms a backhaul link for a radio communication with slave base station 201 or 203 to transmit (relay) transmission data (see the descriptions made later) held by slave base station 202 to slave base station 201 or 203, or to receive transmission data transmitted (relayed) from slave base station 201 or 203. The transmission data held by slave base station 202 is not limited to just transmission data accepted by slave base station 202 from at least one terminal (for example, recorder TL2) in living room RM3 or a communication area with slave base station 202. This transmission data may further include transmission data transmitted (relayed) from slave base station 201 or 203 by multi-hop. Slave base station 203 forms an access link for a radio communication with at least one terminal (for example, surveillance camera TL3) in dining room RM4 or a communication area with slave base station 203 and functions as a base station in a radio communication with surveillance camera TL3. Slave base station 203 receives and accepts transmission data transmitted from, for example, surveillance camera TL3, or transmits transmission data held by the own station (that is, slave base station 203) to surveillance camera TL3.

Slave base station 203 forms a backhaul link for a radio communication with slave base station 202 to transmit (relay) transmission data (see the descriptions made later) held by slave base station 203 to slave base station 202, or to receive transmission data transmitted (relayed) from slave base station 202. The transmission data held by slave base station 203 is transmission data accepted by slave base station 203 from at least one terminal (for example, surveillance camera TL3) in dining room RM4 or a communication area with slave base station 203.

External base station 80 is a base station that relays a communication between application servers APS1, APS2, and APS3 connected via a core network CNW, and master base station 10. A communication path between external base station 80 and the core network CNW is, for example, an optical fiber line, but is not limited to the optical fiber line. For example, the communication path may be a fixed wireless link in a microwave band or a millimeter wave band.

Application servers APS1, APS2, and APS3 are servers that are also referred to as cloud servers and is capable of providing various online services. For example, application server APS1, APS2, or APS3 acquires a response (for example, information or data) to a request of an online service, which is relayed by master base station 10 and external base station 80, based on the request from a terminal. Application server APS1, APS2, or APS3 transmits the response to the terminal through external base station 80 and master base station 10.

FIG. 1 illustrates a configuration in which only one slave base station 201 is connected to master base station 10 through dielectric waveguide DH1. However, a plurality of slave base stations may be connected to the master base station through dielectric waveguides different from each other. For example, slave base station 201 may be connected to master base station 10 through dielectric waveguide DH1. Further, another slave base station (not illustrated) disposed in the attic of private house HME may be connected to master base station 10 through a dielectric waveguide being a member similar to dielectric waveguide DH1.

The number of terminals that perform a radio communication with master base station 10 or slave base station 201, 202, or 203 by an access link is not limited to the example illustrated in FIG. 1. One or a plurality of terminals may be appropriately disposed in accordance with a system configuration or the number of users. This is similarly applied to the following exemplary embodiments.

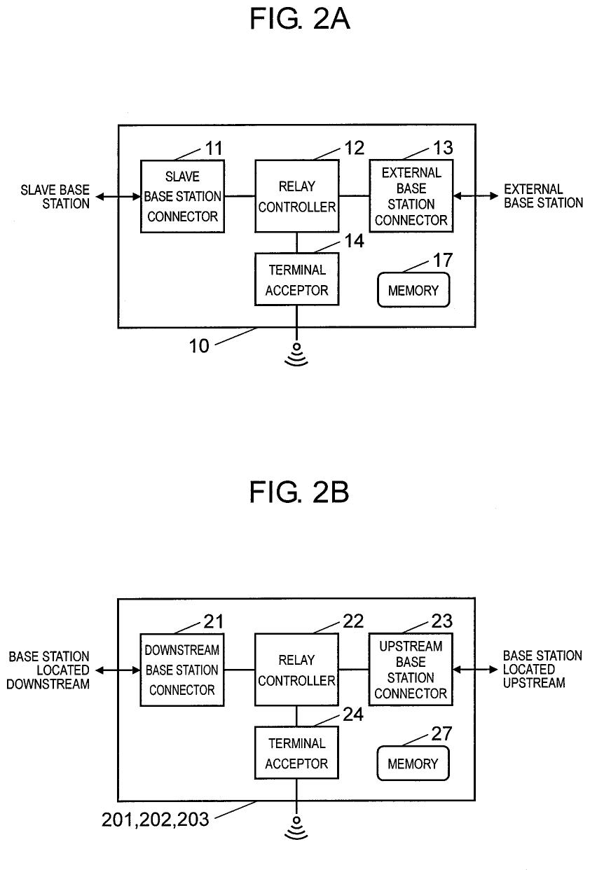

FIG. 2A is a block diagram illustrating a configuration example of master base station 10 in Exemplary Embodiment 1.

FIG. 2B is a block diagram illustrating a configuration example of slave base station 201, 202, or 203 in Exemplary Embodiment 1.

Master base station 10 illustrated in FIG. 2A is disposed in, for example, room RM1 and includes slave base station connector 11, relay controller 12, external base station connector 13, terminal acceptor 14, and memory 17.

Slave base station connector 11 as an example of a second communicator detects a slave base station (for example, slave base station 201) based on a control signal received through dielectric waveguide DH1 and connects slave base station connector 11 to detected slave base station 201. The control signal means a known control signal which is regularly transmitted and received between base stations disposed in the known cellular network system. Detailed descriptions for the control signal will be omitted.

Relay controller 12 is configured using a processor such as a central processing unit (CPU) or a digital signal processor (DSP), for example. The relay controller controls execution of an operation of each component in master base station 10. Specifically, relay controller 12 has a function to relay transmission data (signal) between terminal acceptor 14 and external base station connector 13. Relay controller 12 has a function to relay transmission data (signal) between slave base station connector 11 and external base station connector 13. Relay controller 12 has a function to monitor a state of each of slave base station connector 11, external base station connector 13, and terminal acceptor 14.

If relay controller 12 recognizes a connection form (for example, connection form in a one-stroke manner) between master base station 10 and slave base stations 201, 202, and 203 based on transmission and reception of the control signal as described above, relay controller 12 uniquely determines relay route Tr0 corresponding to logical tree LGT1 illustrated in FIG. 3. Master base station 10 transmits information regarding relay route Tr0 to three slave base stations 201, 202, and 203. Each of three slave base stations 201, 202, and 203 receives the information regarding relay route Tr0 and registers and holds the received information in memory 27, and thereby determines in detail whether or not a base station located upstream of the own station or a base station located downstream of the own station is provided.

External base station connector 13 as an example of a first communicator detects external base station 80 based on the control signal (see the known control signal in the above-described cellular network system) received through antenna Att and connects the external base station connector to detected external base station 80.

Terminal acceptor 14 as an example of a communicator detects a terminal (for example, administrator terminal TL1) based on reception of a control signal (see the known control signal in the above-described cellular network system) transmitted from at least one terminal (for example, administrator terminal TL1 such as a smartphone) in room RM1 or a communication area with master base station 10. Terminal acceptor 14 connects terminal acceptor 14 to the detected terminal (for example, administrator terminal TL1). Terminal acceptor 14 receives transmission data transmitted from the connected terminal (for example, administrator terminal TL1) or transmits transmission data held by master base station 10 to the terminal (for example, administrator terminal TL1).

Memory 17 is configured using a semiconductor memory or a hard disk, for example. Memory 17 includes a read-only memory (ROM) that stores a program and data required for an operation of master base station 10 and a random access memory (RAM) that temporarily holds data referred in the operation of master base station 10. In Exemplary Embodiment 1, memory 17 holds the information (see FIG. 3) regarding a relay route (relay path) of transmission data in multi-hop. Memory 17 holds transmission data accepted by terminal acceptor 14 or holds transmission data transmitted (relayed) from the slave base station (for example, slave base stations 201, 202, and 203) located downstream by multi-hop.

FIG. 3 is a schematic diagram illustrating an example of logical tree LGT1 in Exemplary Embodiment 1.

As illustrated in FIG. 3, one relay route Tr0 is prepared as the relay route of transmission data in multi-hop. That is, relay route Tr0 has a configuration of master base station 10-slave base station 201-slave base station 202-slave base station 203.

Specifically, in relay route Tr0 of transmission data in multi-hop, master base station 10 is a base station on the most upstream, slave base station 201 is a base station located downstream of master base station 10, slave base station 202 is a base station located downstream of slave base station 201, and slave base station 203 is a base station on the most downstream. Information of logical tree LGT1 indicating a relation in relay route Tr0 is registered in memory 17 of master base station 10 in advance.

S1nce slave base stations 201, 202, and 203 have the same configuration, descriptions will be made by using slave base station 201 as an example.

Slave base station 201 illustrated in FIG. 2B is disposed in, for example, room RM2 and includes downstream base station connector 21, relay controller 22, upstream base station connector 23, terminal acceptor 24, and memory 27.

Downstream base station connector 21 as an example of a communicator detects a base station (for example, slave base station 202) located downstream of slave base station 201 based on a control signal (see the known control signal in the above-described cellular network system) received through the dielectric waveguide (for example, dielectric waveguide DH2). Downstream base station connector 21 connects downstream base station connector 21 to the detected base station.

Relay controller 22 is configured using, for example, a processor such as a CPU or a DSP and controls execution of an operation of each component in slave base station 201. Specifically, relay controller 22 has a function to relay transmission data (signal) between terminal acceptor 24 and upstream base station connector 23. Relay controller 22 has a function to relay transmission data (signal) between downstream base station connector 21 and upstream base station connector 23. Relay controller 22 has a function to monitor a state of each of downstream base station connector 21, upstream base station connector 23, and terminal acceptor 24.

Upstream base station connector 23 as an example of the communicator detects a base station (for example, master base station 10) located upstream of slave base station 201 based on a control signal (see the known control signal in the above-described cellular network system) received through the dielectric waveguide (for example, dielectric waveguide DH1). Upstream base station connector 23 connects upstream base station connector 23 to the detected base station.

Terminal acceptor 24 as an example of the communicator detects a terminal based on reception of a control signal transmitted from at least one terminal (not illustrated) in room RM2 or a communication area with slave base station 201. Terminal acceptor 24 connects terminal acceptor 24 to the detected terminal. Terminal acceptor 24 receives transmission data transmitted from the connected terminal or transmits transmission data held by slave base station 201 to the terminal.

Memory 27 is configured using a semiconductor memory or a hard disk, for example. Memory 27 includes a ROM that stores a program and data required for an operation of slave base station 201 and a RAM that temporarily holds data referred in the operation of slave base station 201. In Exemplary Embodiment 1, memory 27 holds the information (see FIG. 3) regarding a relay route (relay path) of transmission data in multi-hop, which has been transmitted from master base station 10. Memory 27 holds transmission data accepted by, for example, terminal acceptor 24 or holds transmission data transmitted (relayed) from master base station 10 or the slave base station (for example, slave base station 202) located downstream by multi-hop.

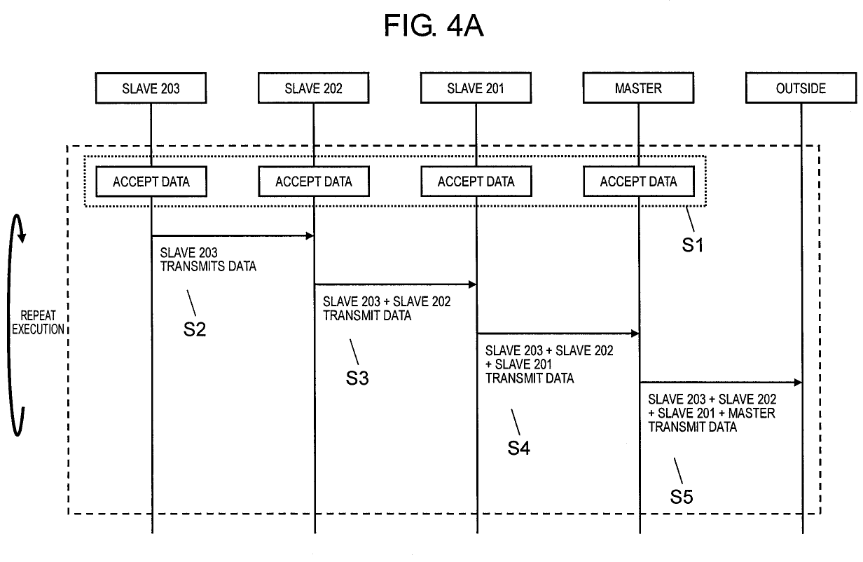

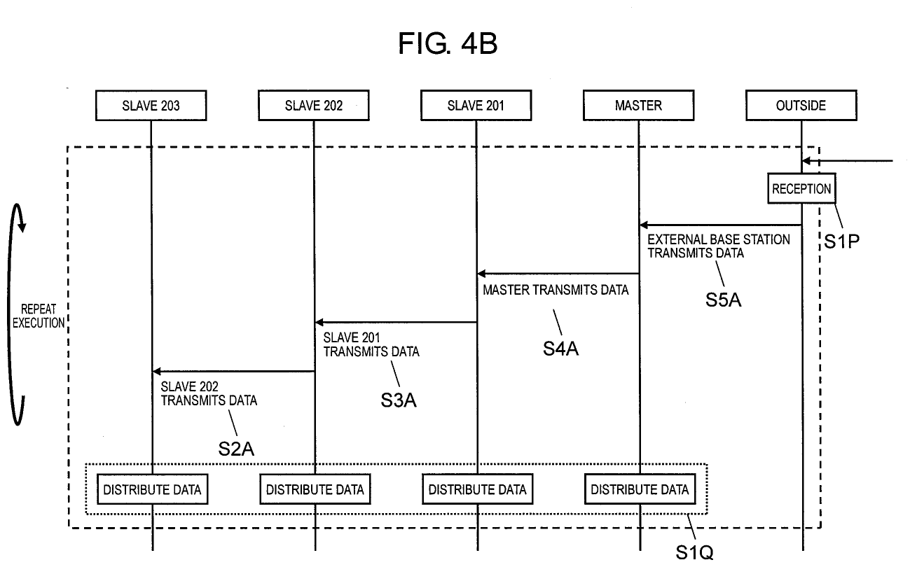

Next, an operation procedure when data transmission is performed between master base station 10 and three slave base stations 201, 202, and 203 in Exemplary Embodiment 1 will be described with reference to FIGS. 4A and 4B. FIG. 4A illustrates an operation procedure at time of using an uplink in which transmission data is transmitted from the base station on the most downstream to the base station on the most upstream in multi-hop. FIG. 4B illustrates an operation procedure at time of using a downlink in which transmission data is transmitted from the base station on the most upstream to the base station on the most downstream in multi-hop.

FIGS. 4A and 4B are sequence diagrams specifically illustrating examples of the operation procedure when data transmission is performed between master base station 10 and three slave base stations 201, 202, and 203 in Exemplary Embodiment 1.

As a premise of the descriptions for FIGS. 4A and 4B, if master base station 10 recognizes a connection form (for example, connection form in a one-stroke manner) between master base station 10 and slave base stations 201, 202, and 203, master base station 10 uniquely determines relay route Tr0 corresponding to logical tree LGT1 illustrated in FIG. 3. Master base station 10 directly or indirectly transmits the information regarding relay route Tr0 to each of three slave base stations 201, 202, and 203 in accordance with relay route Tr0. Each of three slave base stations 201, 202, and 203 receives the information regarding relay route Tr0 and registers and holds the received information in memory 27, and thereby determines in detail whether or not a base station located upstream of the own station or a base station located downstream of the own station is provided.

In FIG. 4A, master base station 10 receives and accepts transmission data transmitted from at least one terminal (for example, administrator terminal TL1) in room RM1 in which master base station 10 is disposed or in a communication area with master base station 10 (S1). Similarly, slave base station 201, 202, or 203 receive and accept transmission data transmitted from at least one terminal in room RM2 in which the own station is disposed, in living room RM3, in dining room RM4, or in a communication area with the own station (S1).

Slave base station 203 positioned on the most downstream in multi-hop transmits transmission data accepted by slave base station 203 to slave base station 202 being a base station positioned upstream of slave base station 203 (S2).

Slave base station 202 associates the transmission data accepted by slave base station 202 in Step S1 with the transmission data transmitted from slave base station 203 in Step S2. Slave base station 202 transmits the result of the association to slave base station 201 being a base station positioned upstream of slave base station 202 (S3).

Slave base station 201 associates the transmission data accepted by slave base station 201 in Step S1 with the transmission data transmitted from slave base station 202 in Step S3. Slave base station 201 transmits the result of the association to master base station 10 being a base station positioned upstream of slave base station 201 (S4).

Master base station 10 associates the transmission data accepted by master base station 10 in Step S1 with the transmission data transmitted from slave base station 201 in Step S4. Master base station 10 transmits the result of the association to external base station 80 through antenna Att (S5). The processes of Step S1 to Step S5 are periodically repeated.

In FIG. 4B, external base station 80 receives transmission data (for example, response to a request from a terminal in private house HME) transmitted from at least one of application servers APS1, APS2, and APS3 (S1P) and transfers (that is, relays) the transmission data to master base station 10 (SSA).

Master base station 10 positioned on the most upstream in multi-hop transmits transmission data transmitted from external base station 80, to slave base station 201 being a base station positioned downstream of master base station 10 (S4A). Master base station 10 distributes the transmission data transmitted from external base station 80 to a terminal allowing master base station 10 to accept transmission data (for example, terminal capable of communicating with master base station 10) (S1Q).

Slave base station 201 transmits the transmission data transmitted from master base station 10 in Step S4A, to slave base station 202 being a base station located downstream of slave base station 201 (S3A). Slave base station 201 distributes the transmission data transmitted from master base station 10 to a terminal allowing slave base station 201 to accept transmission data (for example, terminal capable of communicating with slave base station 201) (S1Q).

Slave base station 202 transmits the transmission data transmitted from slave base station 201 in Step S3A, to slave base station 203 being a base station located downstream of slave base station 202 (S2A). Slave base station 202 distributes the transmission data transmitted from slave base station 201 to a terminal allowing slave base station 202 to accept transmission data (for example, terminal capable of communicating with slave base station 202) (S1Q).

Slave base station 203 receives and acquires the transmission data transmitted from slave base station 202 in Step S2A. Slave base station 203 distributes the transmission data transmitted from slave base station 202 to a terminal allowing slave base station 203 to accept transmission data (for example, terminal capable of communicating with slave base station 203) (S1Q). The processes of Steps S1P, S5A, S4A, S3A, S2A, and S1Q are periodically repeated.

With the above descriptions, in⁻facility transmission system 100 in Exemplary Embodiment 1 is disposed in the facility (for example, private house HME) with the plurality of closed spaces (for example, rooms RM1 and RM2, living room RM3, and dining room RM4). Master base station 10 is disposed in room RM1 and performs a radio communication with external base station 80. Slave base station 201 is disposed in room RM2 different from room RM1 and performs a multi-hop radio communication with master base station 10. Room RM1 and room RM2 are connected to each other through dielectric waveguide DM capable of reducing a propagation loss of a radio wave in the radio communication between master base station 10 and slave base station 201.

Thus, a communication (for example, relay) of transmission data is performed using a high frequency band which is considered for use in 5G, in a state where master base station 10 disposed in room RM1 and slave base station 201 disposed in room RM2 are connected to each other through dielectric waveguide DH1. Thus, when a multi-hop communication between master base station 10 and slave base station 201 is performed, the propagation loss of a radio wave is reduced. Accordingly, it is possible to secure desired communication quality and to realize a stable radio communication.

Slave base station 202 is disposed in living room RM3 and performs a multi-hop radio communication with slave base stations 201 and 203. Room RM2 and living room RM3 are connected to each other through dielectric waveguide DH2 capable of reducing a propagation loss of a radio wave in the radio communication between slave base station 201 and slave base station 202. Thus, a communication (for example, relay) of transmission data is performed using a high frequency band which is considered for use in 5G, in a state where slave base station 201 disposed in room RM2 and slave base station 202 disposed in living room RM3 are connected to each other through dielectric waveguide DH2. Accordingly, when a multi-hop communication between slave base station 201 and slave base station 202 is performed, the propagation loss of a radio wave is reduced. Accordingly, it is possible to secure desired communication quality and to realize a stable radio communication.

Slave base station 203 is disposed in dining room RM4 and performs a multi-hop radio communication with slave base station 202. Living room RM3 and dining room RM4 are connected to each other through dielectric waveguide DH3 capable of reducing a propagation loss of a radio wave in the radio communication between slave base station 202 and slave base station 203. Thus, a communication (for example, relay) of transmission data is performed using a high frequency band which is considered for use in 5G, in a state where slave base station 202 disposed in living room RM3 and slave base station 203 disposed in dining room RM4 are connected to each other through dielectric waveguide DH3. Accordingly, when a multi-hop communication between slave base station 202 and slave base station 203 is performed, the propagation loss of a radio wave is reduced. Accordingly, it is possible to secure desired communication quality and to realize a stable radio communication.

Slave base station 203 transmits transmission data accepted by slave base station 203 to slave base station 202 positioned as a relay destination (for example, base station located upstream) in multi-hop. Slave base station 202 associates the transmission data transmitted from slave base station 203 by multi-hop with the transmission data accepted by slave base station 202, and transmits the result of the association to slave base station 201 positioned as a relay destination (for example, base station located upstream) in multi-hop. Slave base station 201 associates the transmission data transmitted from slave base station 202 by multi-hop with the transmission data accepted by slave base station 201, and transmits the result of the association to master base station 10 positioned as a relay destination (for example, base station located upstream). Accordingly, in in-facility transmission system 100, it is possible to stably perform a radio communication using an uplink across each closed space in private house HME. In addition, it is possible to favorably perform a radio communication using a high frequency band if the user is in a communication area in any base station in private house HME, and to improve convenience of the user.

Master base station 10 receives transmission data (for example, response to a request from the terminal in private house HME) transmitted from external base station 80 and transmits the received transmission data to slave base station 201 positioned as a relay destination (for example, base station located downstream) in multi-hop. Slave base station 201 transmits the transmission data transmitted from master base station 10 by multi-hop, to slave base station 202 positioned as a relay destination (for example, base station located downstream) in multi-hop. Thus, in in-facility transmission system 100, it is possible to stably perform a radio communication using a downlink across each closed space in private house HME. In addition, it is possible to favorably perform a radio communication using a high frequency band if the user is in a communication area in any base station in private house HME, and to improve convenience of the user.

### Exemplary Embodiment 2

In Exemplary Embodiment 1, master base station 10, slave base station 201, slave base station 202, and slave base station 203 are connected to each other through dielectric waveguides DH1, DH2, and DH3 in a one-stroke manner. In Exemplary Embodiment 2, an example in which master base station 10, slave base station 201, slave base station 202, and slave base station 203 are connected to each other in a ring shape through dielectric waveguides DH1, DH2, DH3, and DH4 will be described.

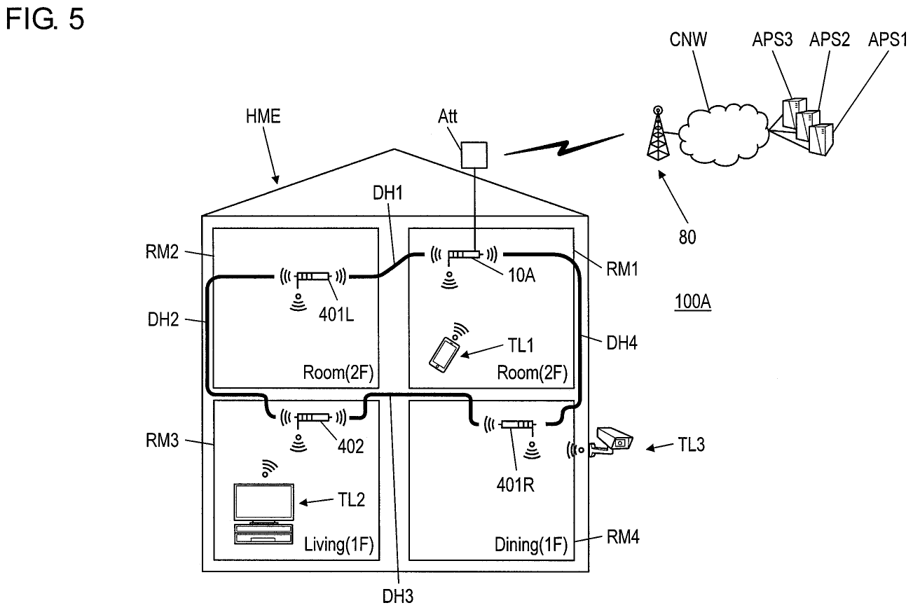

FIG. 5 is a diagram illustrating an example of a specific system configuration in which in-facility transmission system 100A according to Exemplary Embodiment 2 is disposed in a private house.

In-facility transmission system 100A in Exemplary Embodiment 2 includes master base station 10A connected to antenna Att, first slave base station 401L, second slave base station 402, third slave base station 401R, external base station 80, and application servers APS1, APS2, and APS3. In in-facility transmission system 100A in Exemplary Embodiment 2, the same components as those in in-facility transmission system 100 in Exemplary Embodiment 1 are denoted by the same reference marks, and descriptions thereof will be briefly made or be omitted. Different contents will be described.

In private house HME, base stations different from each other are disposed in the four closed spaces. Specifically, master base station 10A is disposed in a room RM1 on the second floor, and slave base station (example of the first slave base station) 401L is disposed in a room RM2 on the second floor. Slave base station (example of the second slave base station) 402 is disposed in living room RM3 on the first floor. Slave base station (example of the third slave base station) 401R is disposed in dining room RM4 on the first floor.

In Exemplary Embodiment 2, room RM1 and room RM2 are connected to each other through dielectric waveguide Dill as an example of the first radio waveguide. Thus, even though master base station 10A and slave base station 401L use a high frequency band (see the above descriptions) of which using in 5G is examined, it is possible to reduce a propagation loss of a radio wave when the master base station and the slave base station perform a radio communication with each other across a blocking object such as the ceiling surface or the wall surface of each of rooms RM1 and RM2. Accordingly, the master base station and the slave base station perform a favorable and stable radio communication with each other.

Room RM2 and living room RM3 are connected through dielectric waveguide DH2 as an example of a second radio waveguide. Thus, even though slave base station 401L and slave base station 402 use the above-described high frequency band, it is possible to reduce a propagation loss of a radio wave when slave base station 401L and slave base station 402 perform a radio communication with each other across a blocking object such as the ceiling surface or the wall surface of each of room RM2 and living room RM3. Accordingly, slave base station 401L and slave base station 402 perform a favorable and stable radio communication with each other.

Living room RM3 and dining room RM4 are connected to each other through dielectric waveguide DH3 as an example of a third radio waveguide. Thus, even though slave base station 402 and slave base station 401R use the above-described high frequency band, it is possible to reduce a propagation loss of a radio wave when slave base station 402 and slave base station 401R perform a radio communication with each other across a blocking object such as the ceiling surface or the wall surface of each of living room RM3 and dining room RM4. Accordingly, slave base station 402 and slave base station 401R perform a favorable and stable radio communication with each other.

Dining room RM4 and room RM1 are connected to each other through dielectric waveguide DH4 as an example of the fourth radio waveguide. Similar to dielectric waveguide DH1, dielectric waveguide DH4 has a tubular shape and is configured using a member capable of reducing a propagation loss of a radio wave in a radio communication in a high frequency band (see the above description) of which using in 5G is examined. Thus, even though slave base station 401R and master base station 10A use the above-described high frequency band, it is possible to reduce a propagation loss of a radio wave when slave base station 401R and master base station 10A perform a radio communication with each other across a blocking object such as the ceiling surface or the wall surface of each of dining room RM4 and room RM1. Accordingly, slave base station 401R and master base station 10A perform a favorable and stable radio communication with each other.

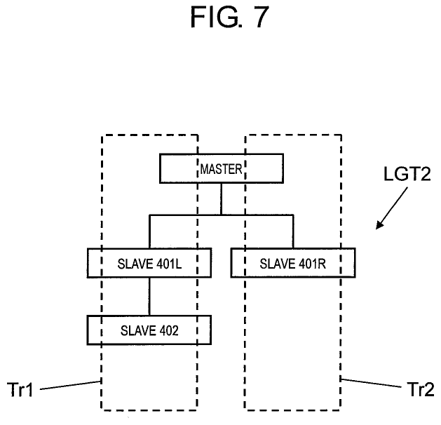

Thus, master base station 10A, slave base station 401L, slave base station 402, and slave base station 401R are connected to each other in a ring shape through dielectric waveguides DHl, DH2, DH3, and DH4. Exemplary Embodiment 2 is different from Exemplary Embodiment 1 in that two relay routes (relay paths) of transmission data in maximum are prepared (see FIG. 7).

FIG. 7 is a schematic diagram illustrating an example of logical tree LGT2 in Exemplary Embodiment 2.

As illustrated in FIG. 7, in Exemplary Embodiment 2, two relay routes Tr1 and Tr2 are prepared as the relay route of transmission data in multi-hop. That is, first relay route Tr1 has a configuration of master base station 10A-slave base station 401L-slave base station 402. Second relay route Tr2 has a configuration of master base station 10A⁻slave base station 401R. That is, although slave base stations 402 and 401R are located in an environment in which a communication between slave base stations 402 and 401R is possible, slave base station 402 and slave base station 401R do not directly perform a radio communication with each other in a normal time except for a special case (see Exemplary Embodiment 3 described later).

In first relay route Tr1, master base station 10A is a base station on the most upstream, slave base station 401L is a base station located downstream of master base station 10A, and slave base station 402 is a base station on the most downstream. In second relay route Tr2, master base station 10A is a base station on the most upstream, and slave base station 401R is a base station on the most downstream. Information of logical tree LGT2 indicating relations in relay routes Tr1 and Tr2 is registered in memory 17 of master base station 10A in advance.

Thus, master base station 10A, slave base station 401L, and slave base station 402 can perform multi-hop radio communications with each other in accordance with first relay route Tr1. Further, master base station 10A and slave base station 401R can perform a multi-hop radio communication with each other in accordance with second relay route Tr2.

Here, each base station (master base station 10A and slave base stations 401L, 402, and 401R) will be described.

Master base station 10A forms an access link for a radio communication with at least one terminal (for example, administrator terminal TL1 such as a smartphone) in room RM1 or a communication area with master base station 10A and functions as a base station in a radio communication with administrator terminal TL1. Master base station 10A receives and accepts transmission data transmitted from, for example, administrator terminal TL1, or transmits transmission data held by the own station (that is, master base station 10A) to administrator terminal TL1.

Master base station 10A performs a radio communication with external base station 80 provided outside private house HME, through antenna Att.

Master base station 10A forms a backhaul link for a radio communication with slave base stations 401L and 401R to transmit (relay) transmission data (see the descriptions made later) held by master base station 10A to external base station 80 or slave base station 401L or 401R, or to receive transmission data transmitted (relayed) from external base station 80 or slave base station 401L or 401R. The transmission data held by master base station 10A is not limited to just transmission data accepted from administrator terminal TL1 by master base station 10 and may further include transmission data transmitted (relayed) from slave base station 401L or 401R by multi-hop.

Slave base station 401L forms an access link for a radio communication with at least one terminal (not illustrated) in room RM2 or a communication area with slave base station 401L and functions as a base station in a radio communication with this terminal. Slave base station 401L receives and accepts transmission data transmitted from, for example, the above terminal, or transmits transmission data held by the own station (that is, slave base station 401L) to the above terminal.

Slave base station 401L forms a backhaul link for a radio communication with master base station 10A or with slave base station 402 to transmit (relay) transmission data (see the descriptions made later) held by slave base station 401L to master base station 10A or slave base station 402, or to receive transmission data transmitted (relayed) from master base station 10A or slave base station 402. The transmission data held by slave base station 401L is not limited to just transmission data accepted by slave base station 401L from at least one terminal (not illustrated) in room RM2 or a communication area with slave base station 401L. This transmission data may further include transmission data transmitted (relayed) from master base station 10A or slave base station 402 by multi-hop.

Slave base station 402 forms an access link for a radio communication with at least one terminal (for example, recorder TL2) in living room RM3 or a communication area with slave base station 402 and functions as a base station in a radio communication with recorder TL2. Slave base station 402 receives and accepts transmission data transmitted from, for example, recorder TL2, or transmits transmission data held by the own station (that is, slave base station 402) to recorder TL2.

Slave base station 402 forms a backhaul link for a radio communication with slave base station 401L or 401R. Thus, slave base station 402 can transmit (relay) transmission data (see the descriptions made later) held by slave base station 402 to slave base station 401L or 401R, or can receive transmission data transmitted (relayed) from slave base station 401L or 401R. The transmission data held by slave base station 402 is not limited to just transmission data accepted by slave base station 402 from at least one terminal (for example, recorder TL2) in living room RM3 or a communication area with slave base station 402. This transmission data may further include transmission data transmitted (relayed) from slave base station 401L or 401R by multi-hop.

Slave base station 401R forms an access link for a radio communication with at least one terminal (for example, surveillance camera TL3) in dining room RM4 or a communication area with slave base station 401R and functions as a base station in a radio communication with surveillance camera TL3. Slave base station 401R receives and accepts transmission data transmitted from, for example, surveillance camera TL3, or transmits transmission data held by the own station (that is, slave base station 401R) to surveillance camera TL3.

Slave base station 401R forms a backhaul link for a radio communication with master base station 10A or slave base station 402. Thus, slave base station 401R can transmit (relay) transmission data (see the descriptions made later) held by slave base station 401R to master base station 10A or slave base station 402, or can receive transmission data transmitted (relayed) from master base station 10A or slave base station 402. The transmission data held by slave base station 401R is transmission data accepted by slave base station 401R from at least one terminal (for example, surveillance camera TL3) in dining room RM4 or a communication area with slave base station 401R.

In FIG. 5, slave base station 401L and slave base station 401R are configured to be enabled to be connected to each other through dielectric waveguide DH2, slave base station 402, and dielectric waveguide DH3. However, slave base station 401L and slave base station 401R may be connected to each other through one dielectric waveguide. That is, slave base station 401L and slave base station 401R may be connected to each other through one dielectric waveguide (not illustrated) joining room RM2 and dining room RM4.

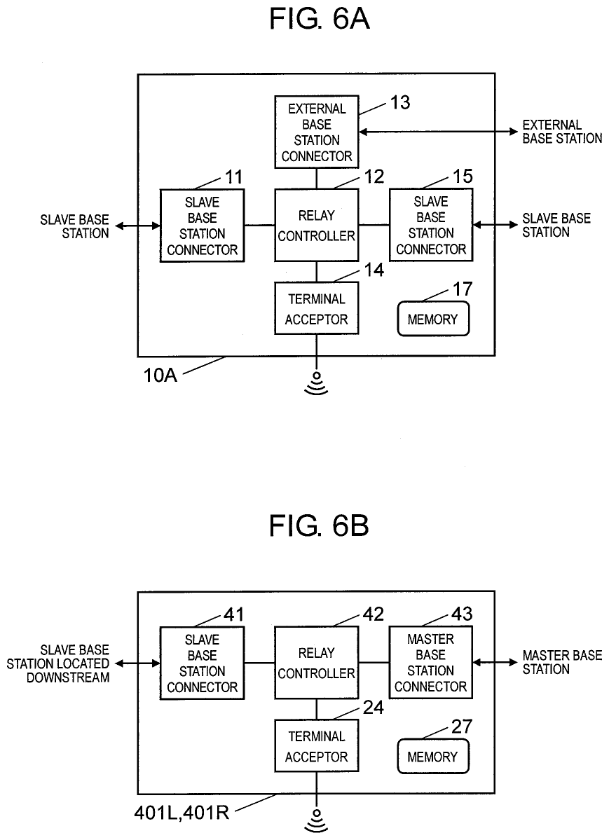

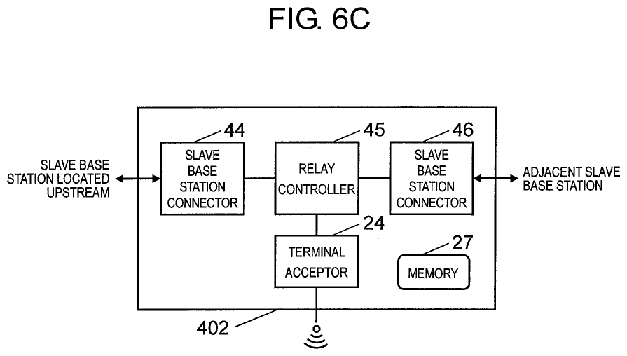

FIG. 6A is a block diagram illustrating a configuration example of master base station 10A in Exemplary Embodiment 2.

FIG. 6B is a block diagram illustrating a first configuration example of the slave base station in Exemplary Embodiment 2.

FIG. 6C is a block diagram illustrating a second configuration example of the slave base station in Exemplary Embodiment 2.

In FIGS. 6A, 6B, and 6C, the same components as those in FIGS. 2A and 2B are denoted by the same reference marks, and descriptions thereof will be briefly made or be omitted. Different contents will be described.

Master base station 10A illustrated in FIG. 6A is disposed in, for example, room RM1 and includes slave base station connector 11, relay controller 12, external base station connector 13, terminal acceptor 14, slave base station connector 15, and memory 17.

Slave base station connector 11 as an example of the second communicator detects a slave base station (for example, slave base station 401L) based on a control signal (see the known control signal in the cellular network system described in Exemplary Embodiment 1) received through dielectric waveguide DH1. Slave base station connector 11 connects slave base station connector 11 to detected slave base station 401L.

If relay controller 12 recognizes a connection form (for example, connection form in a ring shape) between master base station 10A and slave base stations 401L, 402, and 401R, relay controller 12 uniquely determines relay routes Tr1 and Tr2 corresponding to logical tree LGT2 illustrated in FIG. 7. Master base station 10A transmits information regarding relay routes Tr1 and Tr2 to three slave base stations 401L, 402, and 401R. Each of three slave base stations 401L, 402, and 401R receives the information regarding relay routes Tr1 and Tr2 and registers and holds the received information in memory 27, and thereby determines in detail whether or not a base station located upstream of the own station or a base station located downstream of the own station is provided.

Slave base station connector 15 as an example of the second communicator detects a base station (for example, slave base station 401R) based on a control signal (see the known control signal in the cellular network system described in Exemplary Embodiment 1) received through dielectric waveguide DH4. Slave base station connector 15 connects slave base station connector 15 to detected slave base station 401R.

Memory 17 is configured using a semiconductor memory or a hard disk, for example. Memory 17 includes a ROM that stores a program and data required for an operation of master base station 10A and a RAM that temporarily holds data referred in the operation of master base station 10A. In Exemplary Embodiment 2, memory 17 holds the information (see FIG. 7) regarding a relay route (relay path) of transmission data in multi-hop. Memory 17 holds transmission data accepted by terminal acceptor 14 or holds transmission data transmitted (relayed) from the slave base station (for example, slave base stations 401L, 402, and 401R) located downstream by multi-hop.

Slave base stations 401L and 401R illustrated in FIG. 6B are disposed in, for example, room RM2 and dining room RM4, respectively. Each of slave base stations 401L and 401R includes slave base station connector 41, relay controller 42, master base station connector 43, terminal acceptor 24, and memory 27. S1nce slave base stations 401L and 401R have the same configuration, descriptions will be made by using slave base station 401L as an example.

Slave base station connector 41 as an example of the communicator detects a base station (for example, slave base station 402) located downstream of slave base station 401L based on a control signal (see the known control signal in the above-described cellular network system) received through the dielectric waveguide (for example, dielectric waveguide DH2). Slave base station connector 41 connects slave base station connector 41 to the detected base station.

Relay controller 42 is configured using, for example, a processor such as a CPU or a DSP and controls execution of an operation of each component in slave base station 401L. Specifically, relay controller 42 has a function to relay transmission data (signal) between terminal acceptor 24 and master base station connector 43. Relay controller 42 has a function to relay transmission data (signal) between slave base station connector 41 and master base station connector 43. Relay controller 42 has a function to monitor a state of each of slave base station connector 41, master base station connector 43, and terminal acceptor 24.

Master base station connector 43 as an example of the communicator detects a base station (for example, master base station 10A) located upstream of slave base station 401L based on a control signal (see the known control signal in the above-described cellular network system) received through the dielectric waveguide (for example, dielectric waveguide DH1). Master base station connector 43 connects master base station connector 43 to the detected base station.

Memory 27 is configured using a semiconductor memory or a hard disk, for example. Memory 27 includes a ROM that stores a program and data required for an operation of slave base station 401L and a RAM that temporarily holds data referred in the operation of slave base station 401L. In Exemplary Embodiment 2, memory 27 holds the information (see FIG. 7) regarding a relay route (relay path) of transmission data in multi-hop, which has been transmitted from master base station 10A. Memory 27 holds transmission data accepted by, for example, terminal acceptor 24 or holds transmission data transmitted (relayed) from master base station 10A or the slave base station (for example, slave base station 402) located downstream by multi-hop.

Slave base station 402 illustrated in FIG. 6C is disposed in, for example, living room RM3 and includes slave base station connector 44, relay controller 45, slave base station connector 46, terminal acceptor 24, and memory 27.

Slave base station connector 44 as an example of the communicator detects a base station (for example, slave base station 401L) located upstream of slave base station 402 based on a control signal (see the known control signal in the above-described cellular network system) received through the dielectric waveguide (for example, dielectric waveguide DH2). Slave base station connector 44 connects slave base station connector 44 to the detected base station.

Relay controller 45 is configured using, for example, a processor such as a CPU or a DSP and controls execution of an operation of each component in slave base station 402. Specifically, relay controller 45 has a function to relay transmission data (signal) between terminal acceptor 24 and slave base station connector 44. Relay controller 45 has a function to relay transmission data (signal) between slave base station connector 44 and slave base station connector 46. Relay controller 45 has a function to monitor a state of each of slave base station connector 44, slave base station connector 46, and terminal acceptor 24.

Slave base station connector 46 as an example of the communicator detects a base station (for example, slave base station 401R) adjacent to slave base station 402 based on a control signal (see the known control signal in the above-described cellular network system) received through the dielectric waveguide (for example, dielectric waveguide DH3). Slave base station connector 46 connects slave base station connector 46 to the detected base station.

Memory 27 is configured using a semiconductor memory or a hard disk, for example. Memory 27 includes a ROM that stores a program and data required for an operation of slave base station 402 and a RAM that temporarily holds data referred in the operation of slave base station 402. In Exemplary Embodiment 2, memory 27 holds the information (see FIG. 7) regarding a relay route (relay path) of transmission data in multi-hop, which has been transmitted from master base station 10A. Memory 27 holds transmission data accepted by terminal acceptor 24 or holds transmission data transmitted (relayed) from master base station 10A by multi-hop.

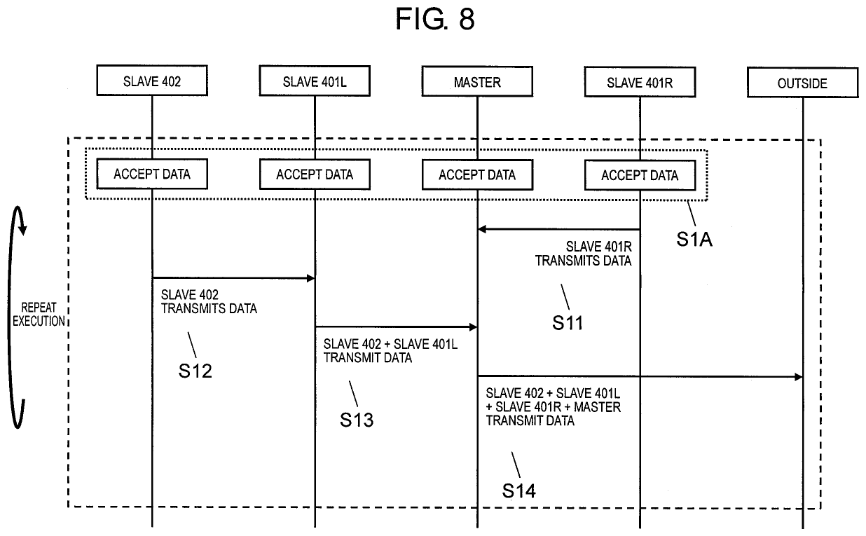

Next, an operation procedure when data transmission is performed between master base station 10A and three slave base stations 401L, 402, and 401R in Exemplary Embodiment 2 will be described with reference to FIG. 8. FIG. 8 illustrates an operation procedure at time of using an uplink in which transmission data is transmitted from the base station on the most downstream to the base station on the most upstream in multi-hop.

FIG. 8 is a sequence diagram specifically illustrating an example of an operation procedure when data transmission is performed between master base station 10A and three slave base stations 401L, 402, and 401R in Exemplary Embodiment 2.

As a premise of the descriptions for FIG. 8, if master base station 10A recognizes a connection form (for example, connection form in a ring shape) between master base station 10A and slave base stations 401L, 402, and 401R, for example, based on the transmission and reception of the above-described control signal, master base station 10A uniquely determines relay routes Tr1 and Tr2 corresponding to logical tree LGT2 illustrated in FIG. 7. Master base station 10A directly or indirectly transmits the information regarding relay routes Tr1 and Tr2 to each of three slave base stations 401L, 402, and 401R in accordance with relay routes Tr1 and Tr2. Each of three slave base stations 401L, 402, and 401R receives the information regarding relay routes Tr1 and Tr2 and registers and holds the received information in memory 27, and thereby determines in detail whether or not a base station located upstream of the own station or a base station located downstream of the own station is provided.

In FIG. 8, master base station 10A receives and accepts transmission data transmitted from at least one terminal (for example, administrator terminal TL1) in room RM1 in which master base station 10A is disposed or in a communication area with master base station 10A (S1A). Similarly, slave base stations 401L, 402, and 401R receive and accept transmission data transmitted from at least one terminal in room RM2 in which the own station is disposed, in living room RM3, in dining room RM4, or in a communication area with the own station (S1A).

In Exemplary Embodiment 2, slave base station 401R positioned on the most downstream in relay route Tr2 in multi-hop transmits transmission data accepted by slave base station 401R to master base station 10A being a base station positioned upstream of slave base station 401R (S11).

Slave base station 402 positioned on the most downstream in relay route Tr1 in multi-hop transmits transmission data accepted by slave base station 402 to slave base station 401L being a base station positioned upstream of slave base station 402 (S12).

Slave base station 401L associates the transmission data accepted by slave base station 401L in Step S1A with the transmission data transmitted from slave base station 402 in Step S12. Slave base station 401L transmits the result of the association to master base station 10A being a base station positioned upstream of slave base station 401L (S13).

Master base station 10A associates the transmission data accepted by master base station 10A in Step S1A, the transmission data transmitted from slave base station 401R in Step S11, and the transmission data transmitted from slave base station 401L in Step S13 with each other. Master base station 10A transmits the result of the association to external base station 80 through antenna Att (S14). The processes of Step S1A and Step S11 to Step S14 are periodically repeated.

Here, although not illustrated, differing from FIG. 8, an operation procedure when transmission data is transmitted from the base station (that is, master base station 10A) on the most upstream in multi-hop to the base station located downstream in accordance with each of relay routes Tr0 and Tr1, by using a downlink will be described.

External base station 80 receives transmission data (for example, response to a request from a terminal in private house HME) transmitted from at least one of application servers APS1, APS2, and APS3 and transfers (that is, relays) the transmission data to master base station 10A.

Master base station 10A positioned on the most upstream in multi-hop transmits transmission data transmitted from external base station 80, to slave base stations 401L and 401R being base stations positioned downstream of master base station 10A. Master base station 10A distributes the transmission data transmitted from external base station 80 to a terminal allowing master base station 10A to accept transmission data (for example, terminal capable of communicating with master base station 10).

Slave base station 401L transmits the transmission data transmitted from master base station 10A to slave base station 402 being a base station located downstream of slave base station 401L. Slave base station 401L distributes the transmission data transmitted from master base station 10A to a terminal allowing slave base station 401L to accept transmission data (for example, terminal capable of communicating with slave base station 401L).

Slave base station 402 distributes the transmission data transmitted from slave base station 401L to a terminal allowing slave base station 402 to accept transmission data (for example, terminal capable of communicating with slave base station 402).

Slave base station 401R receives and acquires transmission data transmitted from master base station 10A. Slave base station 401R distributes the transmission data transmitted from master base station 10A to a terminal allowing slave base station 401R to accept transmission data (for example, terminal capable of communicating with slave base station 401R). As described above, the operation procedure when transmission data is transmitted from the base station (that is, master base station 10A) on the most upstream in multi-hop to the base station located downstream in accordance with each of relay routes Tr0 and Tr1, by using the downlink is periodically repeated.

Thus, in in-facility transmission system 100A in Exemplary Embodiment 2, room RM1 and room RM2 are connected to each other through dielectric waveguide Dill capable of reducing a propagation loss of a radio wave in the radio communication between master base station 10A and slave base station 401L. Room RM2 and living room RM3 are connected to each other through dielectric waveguide DH2 capable of reducing a propagation loss of a radio wave in the radio communication between slave base station 401L and slave base station 402. Slave base station 401R is disposed in dining room RM4 and performs a multi-hop radio communication with master base station 10A. Dining room RM4 and room RM1 are connected to each other through dielectric waveguide DH4 capable of reducing a propagation loss of a radio wave in the radio communication between slave base station 401R and master base station 10A. In a normal time, a multi-hop radio communication is not performed between slave base station 402 and slave base station 401R. However, living room RM3 and dining room RM4 are connected to each other through dielectric waveguide DH3 capable of reducing a propagation loss of a radio wave in the radio communication between slave base station 402 and slave base station 401R, as a communication environment.

Thus, in in-facility transmission system 100A in Exemplary Embodiment 2, master base station 10A can be connected to slave base stations 401L, 402, and 401R through dielectric waveguides DH1, DH2, DH3, and DH4 in a ring shape. Thus, in in-facility transmission system 100A, for example, a redundant line for the purpose of improving problem tolerance can be effectively set as a multi-hop radio communication link in private house HME of the user.

Master base station 10A holds the information regarding the relay route (relay path) of transmission data in memory 17, and directly or indirectly notifies each of slave base stations 401L, 402, and 401R of the information regarding relay routes Tr1 and Tr2 of transmission data. Each of slave base stations 401L, 402, and 401R transmits transmission data accepted by the own station or transmits the transmission data accepted by the own station and transmission data transmitted from the slave base station located downstream of the own station, to master base station 10A or the slave base station as the relay destination, based on the information regarding relay routes Tr1 and Tr2 of the transmission data, of which the notification is received from master base station 10A.

Thus, in in-facility transmission system 100A, it is possible to secure two relay routes from the slave base station on the most downstream to master base station 10A on the most upstream in maximum. Accordingly, it is possible to separately deliver transmission data to master base station 10A in accordance with each of the relay routes. In other words, in in-facility transmission system 100A, it is possible to suppress an increase of transmission data held by the slave base station on the multi-hop relay route in comparison to a case of securing only one relay route as in Exemplary Embodiment 1. Thus, it is possible to effectively suppress an increase of traffic when relaying transmission data and to reduce deterioration of communication quality.

Master base station 10A holds the information regarding the relay route (relay path) of transmission data in memory 17, and directly or indirectly notifies each of slave base stations 401L, 402, and 401R of the information regarding relay routes Tr1 and Tr2 of transmission data. Master base station 10A receives transmission data transmitted from external base station 80 and transmits the received transmission data to slave base stations 401L and 401R as the relay destination, based on the information regarding relay routes Tr1 and Tr2. Slave base station 401L transmits transmission data transmitted from master base station 10A to slave base station 402 as the relay destination, based on the information regarding relay route Tr1 of the transmission data, of which the notification is received from master base station 10A.

Thus, in in-facility transmission system 100A, it is possible to secure two relay routes from the slave base station on the most downstream to master base station 10A on the most upstream in maximum. Accordingly, it is possible to separately deliver transmission data from master base station 10A to the slave base station on the most downstream in accordance with each of the relay routes. In other words, in in-facility transmission system 100A, in comparison to a case of securing only one relay route as in Exemplary Embodiment 1, it is possible to rapidly relay transmission data transmitted from external base station 80, to the slave base station or a terminal connected to this slave base station. Thus, it is possible to provide a favorable communication environment for the user.

### Exemplary Embodiment 3

In Exemplary Embodiment 3, an example in which a multi-hop relay route is changed when a problem occurs in, for example, any slave base station or a dielectric waveguide which is connected to the slave base station in radio among the master base station and the plurality of slave base stations connected in a ring shape, such that using the slave base station or the dielectric waveguide in which the problem occurs is avoided will be described. Hereinafter, in order to make the descriptions easy to understand, an example in which a problem (for example, abnormality such as a failure) occurs in any slave base station will be described. However, the following descriptions can be similarly applied to a case where a problem occurs in a dielectric waveguide connected to the slave base station in radio.

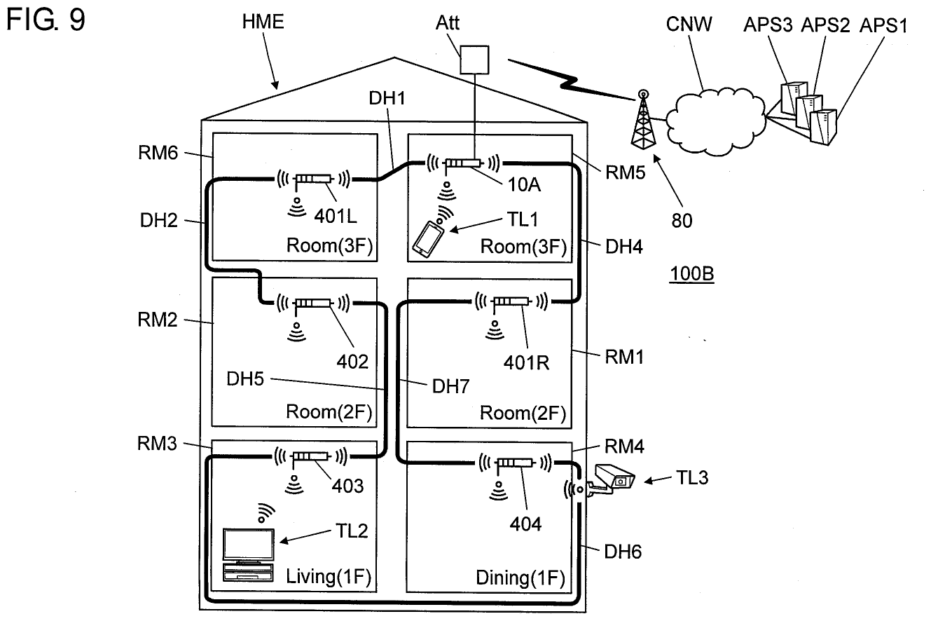

FIG. 9 is a diagram illustrating an example of a specific system configuration in which in-facility transmission system 100B according to Exemplary Embodiment 3 is disposed in a private house.

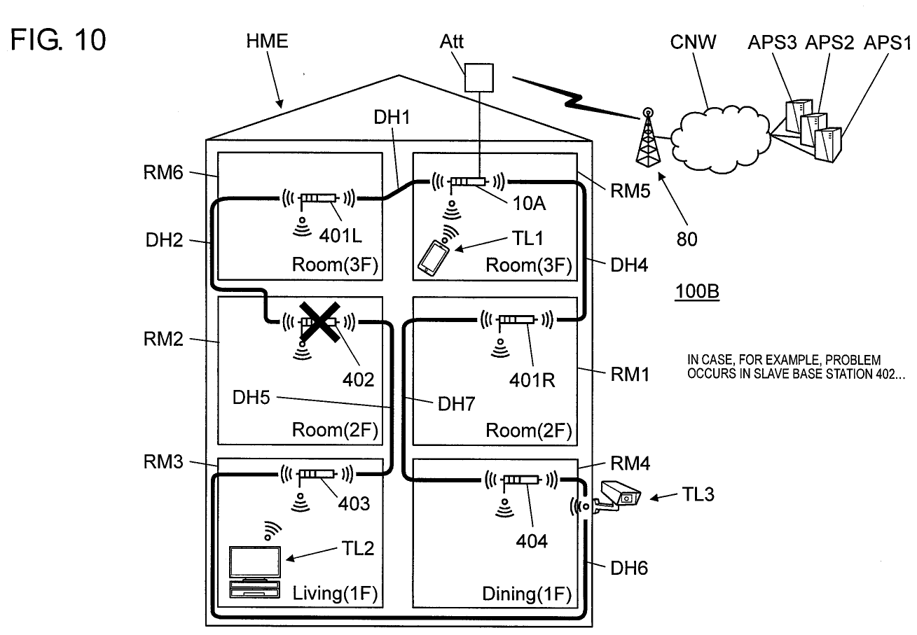

FIG. 10 is a diagram illustrating a case where a problem occurs in a slave base station 402 disposed in a room on the second floor.

In-facility transmission system 100B in Exemplary Embodiment 3 includes master base station 10A connected to antenna Att, first slave base station 401L, second slave base station 402, third slave base station 401R, fourth slave base station 403, fifth slave base station 404, external base station 80, and application servers APS1, APS2, and APS3. In in-facility transmission system 100B in Exemplary Embodiment 3, the same components as those in in-facility transmission systems 100 and 100A in Exemplary Embodiments 1 and 2 are denoted by the same reference marks, and descriptions thereof will be briefly made or be omitted. Different contents will be described.

In private house HME, base stations different from each other are disposed in six closed spaces. Specifically, master base station 10A is disposed in a room RM5 on the third floor, and slave base station (example of the first slave base station) 401L is disposed in a room RM6 on the third floor. Slave base station (example of the second slave base station) 402 is disposed in room RM2 on the second floor. Slave base station (example of the third slave base station) 401R is disposed in room RM1 on the second floor. Slave base station (example of a fourth slave base station) 403 is disposed in living room RM3 on the first floor. Slave base station (example of a fifth slave base station) 404 is disposed in dining room RM4 on the first floor.

In Exemplary Embodiment 3, room RM5 and room RM6 are connected to each other through dielectric waveguide Dill as an example of the first radio waveguide. Thus, even though master base station 10A and slave base station 401L use a high frequency band (see the above descriptions) of which using in 5G is examined, it is possible to reduce a propagation loss of a radio wave when master base station 10A and slave base station 401L perform a radio communication with each other across a blocking object such as the ceiling surface or the wall surface of each of rooms RM5 and RM6. Accordingly, master base station 10A and slave base station 401L perform a favorable and stable radio communication with each other.

Similarly, room RM6 and room RM2 are connected to each other through dielectric waveguide DH2 as an example of a second radio waveguide. Thus, even though slave base station 401L and slave base station 402 use the above-described high frequency band, it is possible to reduce a propagation loss of a radio wave when slave base station 401L and slave base station 402 perform a radio communication with each other across a blocking object such as the ceiling surface or the wall surface of each of the rooms RM6 and RM2. Accordingly, slave base station 401L and slave base station 402 perform a favorable and stable radio communication with each other.

Similarly, room RM2 and living room RM3 are connected to each other through dielectric waveguide DH5 as an example of a fifth radio waveguide. Similar to dielectric waveguide DH1, dielectric waveguide DH5 has a tubular shape and is configured using a member capable of reducing a propagation loss of a radio wave in a radio communication in a high frequency band (see the above description) of which using in 5G is examined. Thus, even though slave base station 402 and slave base station 403 use the above-described high frequency band, it is possible to reduce a propagation loss of a radio wave when slave base station 402 and slave base station 403 perform a radio communication with each other across a blocking object such as the ceiling surface or the wall surface of each of room RM2 and living room RM3. Accordingly, slave base station 402 and slave base station 403 perform a favorable and stable radio communication with each other.

Similarly, living room RM3 and dining room RM4 are connected to each other through dielectric waveguide DH6 as an example of a sixth radio waveguide. Similar to dielectric waveguide DH1, dielectric waveguide DH6 has a tubular shape and is configured using a member capable of reducing a propagation loss of a radio wave in a radio communication in a high frequency band (see the above description) of which using in 5G is examined. Thus, even though slave base station 403 and slave base station 404 use the above-described high frequency band, it is possible to reduce a propagation loss of a radio wave when slave base station 403 and slave base station 404 perform a radio communication with each other across a blocking object such as the ceiling surface or the wall surface of each of living room RM3 and dining room RM4. Accordingly, slave base station 403 and slave base station 404 perform a favorable and stable radio communication with each other.

Similarly, dining room RM4 and room RM1 are connected to each other through dielectric waveguide DH7 as an example of a seventh radio waveguide. Similar to dielectric waveguide DH1, dielectric waveguide DH7 has a tubular shape and is configured using a member capable of reducing a propagation loss of a radio wave in a radio communication in a high frequency band (see the above description) of which using in 5G is examined. Thus, even though slave base station 404 and slave base station 401R use the above-described high frequency band, it is possible to reduce a propagation loss of a radio wave when slave base station 404 and slave base station 401R perform a radio communication with each other across a blocking object such as the ceiling surface or the wall surface of each of dining room RM4 and room RM1. Accordingly, slave base station 404 and slave base station 401R perform a favorable and stable radio communication with each other.

Similarly, room RM1 and room RM5 are connected to each other through dielectric waveguide DH4 as an example of a fourth radio waveguide. Thus, even though slave base station 401R and master base station 10A use the above-described high frequency band, it is possible to reduce a propagation loss of a radio wave when slave base station 401R and master base station 10A perform a radio communication with each other across a blocking object such as the ceiling surface or the wall surface of each of rooms RM1 and RM5. Accordingly, slave base station 401R and master base station 10A perform a favorable and stable radio communication with each other.

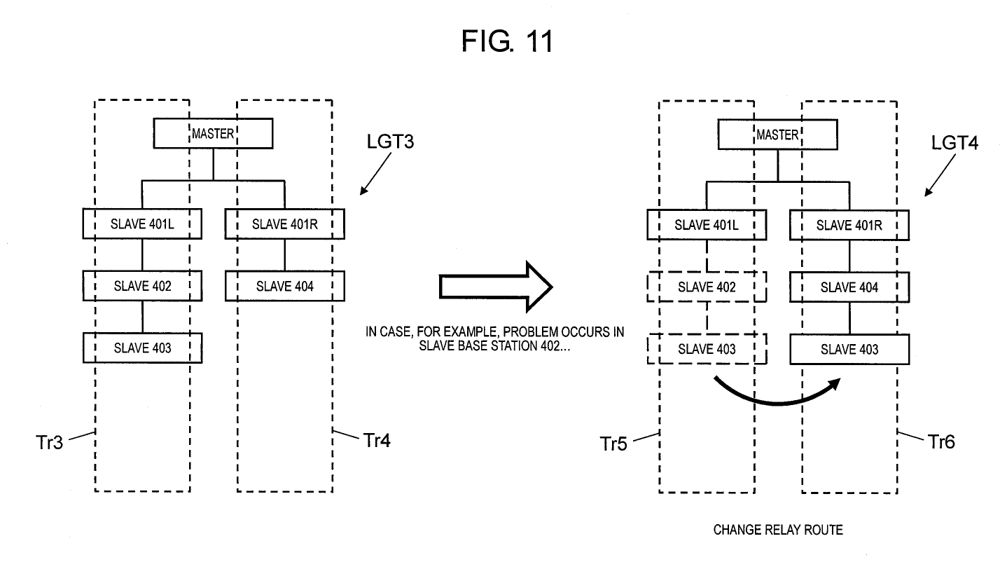

Thus, in Exemplary Embodiment 3, master base station 10A, slave base station 401L, slave base station 402, slave base station 403, slave base station 404, and slave base station 401R are connected to each other in a ring shape through dielectric waveguides DH1, DH2, DH5, DH6, DH7, and DH4. In Exemplary Embodiment 3, similar to Exemplary Embodiment 2, two relay routes (relay paths) of transmission data in maximum are prepared (see logical tree LGT3 in FIG. 11).

FIG. 11 is a diagram illustrating an example of a transition of a logical tree caused by the occurrence of the problem in slave base station 402.

Firstly, logical tree LGT3 in the normal time in which a problem does not occur in any slave base station in the Exemplary Embodiment 3 will be described. As illustrated in FIG. 11, in Exemplary Embodiment 3, two relay routes Tr3 and Tr4 are prepared as the relay route of transmission data in multi-hop. That is, first relay route Tr3 has a configuration of master base station 10A-slave base station 401L-slave base station 402-slave base station 403. Second relay route Tr4 has a configuration of master base station 10A-slave base station 401R-slave base station 404. That is, although slave base stations 403 and 404 are located in an environment in which a communication between slave base stations 403 and 404 is possible, slave base station 403 and slave base station 404 do not directly perform a radio communication with each other in a normal time except for a special case (at time of a problem occurring described later).

In first relay route Tr3, master base station 10A is a base station on the most upstream, slave base station 401L is a base station located downstream of master base station 10A, and slave base station 402 is a base station located downstream of slave base station 401L, and slave base station 403 is a base station on the most downstream. In second relay route Tr4, master base station 10A is a base station on the most upstream, slave base station 401R is a base station located downstream of master base station 10A, and slave base station 404 is a base station on the most downstream. Information of logical tree LGT3 indicating relations in relay routes Tr3 and Tr4 is registered in memory 17 of master base station 10A in advance.

Thus, in Exemplary Embodiment 3, master base station 10A, slave base station 401L, slave base station 402, and slave base station 403 can perform multi-hop radio communications with each other in accordance with first relay route Tr3. Further, master base station 10A, slave base station 401R, and slave base station 404 can perform a multi⁻hop radio communication with each other in accordance with second relay route Tr4.

In Exemplary Embodiment 3, the configuration of master base station 10A is the same as the configuration (see FIG. 6A) of master base station 10A in Exemplary Embodiment 2, and the configuration of slave base stations 401L, 401R, and 402 is also the same as the configuration of slave base stations 401L (see FIG. 6B), 401R (see FIG. 6B), and 402 (see FIG. 6C) in Exemplary Embodiment 2. Thus, detailed descriptions thereof will be omitted. In Exemplary Embodiment 3, the configuration of slave base stations 403 and 404 is also the same as the configuration of slave base station 402 (see FIG. 6C) in Exemplary Embodiment 2. Thus, detailed descriptions thereof will be omitted.

Next, in in-facility transmission system 100B in Exemplary Embodiment 3, an outline of an operation of master base station 10A when a problem occurs in any slave base station (for example, slave base station 402) will be described.

It is assumed that, in a case where in-facility transmission system 100B in Exemplary Embodiment 3 is incorporated into the known cellular network system, a problem occurs in slave base station 402 (see FIG. 10). In this case, slave base stations 401L and 403 which perform a radio communication with slave base station 402 until the problem occurs do not receive the control signal (see the known control signal in the above⁻described cellular network system) periodically transmitted from slave base station 402.

Slave base stations 401L and 403 determine that a problem occurs in slave base station 402, based on the detection that the control signal from slave base station 402 is not received. Slave base station 401L generates a problem detection signal including identification information of slave base station 402 and transmits the problem detection signal to master base station 10A located upstream. If slave base station 403 determines that the problem occurs in slave base station 402, slave base station 403 starts a radio communication with slave base station 404 through dielectric waveguide DH6 which is not used in the normal time. Then, similar to slave base station 401L, slave base station 403 transmits a problem detection signal including identification information of slave base station 402 to slave base station 404. If slave base station 404 receives the problem detection signal transmitted from slave base station 403, slave base station 404 transmits the received problem detection signal to slave base station 401R located upstream. If slave base station 401R receives the problem detection signal transmitted from slave base station 403, slave base station 401R transmits the received problem detection signal to master base station 10A located upstream.

Thus, master base station 10A can correctly determine that the problem occurs in slave base station 402. When master base station 10A receives both the problem detection signals from, for example, slave base stations 401L and 403, master base station 10A may determine that the problem occurs in slave base station 402, or master base station 10A may determine that the problem occurs in slave base station 402, by receiving the problem detection signal from any one (for example, slave base station 401L).

If master base station 10A determines that the problem occurs in slave base station 402, as illustrated in FIG. 11, master base station 10A changes logical tree LGT4 (that is, multi-hop relay route) to avoid using of slave base station 402 in which the problem occurs. Specifically, master base station 10A changes relay routes Tr3 and Tr4 to relay routes Tr5 and Tr6 such that slave base station 403 being a base station positioned downstream of slave base station 402 serves as a base station located downstream of slave base station 404. Thus, relay route Tr5 updated by changing relay route Tr3 has a configuration of master base station 10A-slave base station 401L. Relay route Tr6 updated by changing relay route Tr4 has a configuration of master base station 10A-slave base station 401R-slave base station 404-slave base station 403.

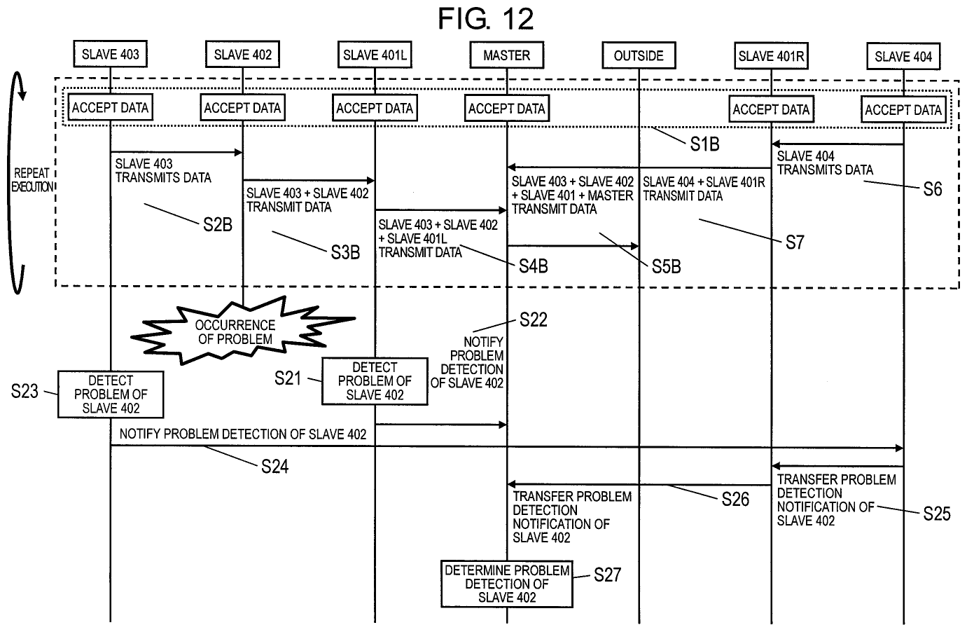

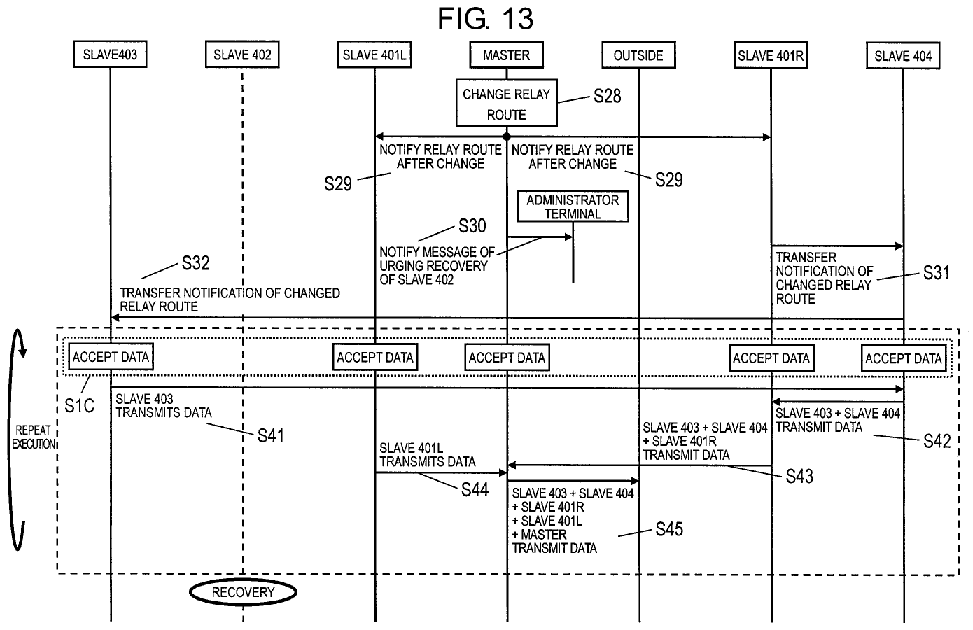

Next, an operation procedure when data transmission is performed between master base station 10A and five slave base stations 401L, 402, 403, 404, and 401R in Exemplary Embodiment 3 will be described with reference to FIGS. 12 and 13.

FIGS. 12 and 13 is a sequence diagram specifically illustrating an example of an operation procedure when data transmission is performed between master base station 10A and five slave base stations 401L, 402, 403, 404, and 401R in Exemplary Embodiment 3.

As a premise of the descriptions for FIGS. 12 and 13, if master base station 10A recognizes a connection form (for example, connection form in a ring shape) between master base station 10A and slave base stations 401L, 402, 403, 404, and 401R, master base station 10A uniquely determines relay routes Tr3 and Tr4 corresponding to logical tree LGT3 illustrated on the left side in FIG. 11. Master base station 10A directly or indirectly transmits the information regarding relay routes Tr3 and Tr4 to each of five slave base stations 401L, 402, 403, 404, and 401R in accordance with relay routes Tr3 and Tr4. Each of five slave base stations 401L, 402, 403, 404, and 401R receives the information regarding relay routes Tr3 and Tr4 and registers and holds the received information in memory 27, and thereby determines in detail whether or not a base station located upstream of the own station or a base station located downstream of the own station is provided.

In FIG. 12, master base station 10A receives and accepts transmission data transmitted from at least one terminal (for example, administrator terminal TL1) in room RM1 in which master base station 10A is disposed or in a communication area with master base station 10A (S1B). Similarly, slave base stations 401L, 402, 403, 404, and 401R receive and accept transmission data transmitted from at least one terminal in room RM6 in which the own station is disposed, in room RM2, in living room RM3, in dining room RM4, in room RM1, or in a communication area with the own station (S1B).

In Exemplary Embodiment 3, slave base station 404 being a base station positioned on the most downstream in relay route Tr4 in multi-hop transmits transmission data accepted by slave base station 404 to slave base station 401R being a base station positioned upstream of slave base station 404 (S6). Slave base station 401R associates the transmission data accepted by slave base station 401R in Step S1B with the transmission data transmitted from slave base station 404 in Step S6. Slave base station 401R transmits the result of the association to master base station 10A being a base station positioned upstream of slave base station 401R (S7).

Slave base station 403 positioned on the most downstream in relay route Tr3 in multi-hop transmits transmission data accepted by slave base station 403 to slave base station 402 being a base station positioned upstream of slave base station 403 (S2B). Slave base station 402 associates the transmission data accepted by slave base station 402 in Step S1B with the transmission data transmitted from slave base station 403 in Step S2B. Slave base station 402 transmits the result of the association to slave base station 401L being a base station positioned upstream of slave base station 402 (S3B). Slave base station 401L associates the transmission data accepted by slave base station 401L in Step S1B with the transmission data transmitted from slave base station 402 in Step S3B. Slave base station 401L transmits the result of the association to master base station 10A being a base station positioned upstream of slave base station 401L (S4B).

Master base station 10A associates the transmission data accepted by master base station 10A in Step S1B, the transmission data transmitted from slave base station 401R in Step S7, and the transmission data transmitted from slave base station 401L in Step S4B with each other. Master base station 10A transmits the result of the association to external base station 80 through antenna Att (S5B). The processes of Step S1B, Step S6 to Step S7, and Step S2B to Step S5B are periodically repeated.

Here, although not illustrated, differing from FIG. 12, an operation procedure when transmission data is transmitted from the base station (that is, master base station 10A) on the most upstream in multi-hop to the base station located downstream in accordance with each of relay routes Tr3 and Tr4, by using a downlink will be described.

External base station 80 receives transmission data (for example, response to a request from a terminal in private house HME) transmitted from at least one of application servers APS1, APS2, and APS3 and transfers (that is, relays) the transmission data to master base station 10A.

Master base station 10A being a base station positioned on the most upstream in multi-hop transmits transmission data transmitted from external base station 80, to slave base stations 401L and 401R being base stations positioned downstream of master base station 10A. Master base station 10A distributes the transmission data transmitted from external base station 80 to a terminal allowing master base station 10A to accept transmission data (for example, terminal capable of communicating with master base station 10).

Slave base station 401L transmits the transmission data transmitted from master base station 10A to slave base station 402 being a base station located downstream of slave base station 401L. Slave base station 401L distributes the transmission data transmitted from master base station 10A to a terminal allowing slave base station 401L to accept transmission data (for example, terminal capable of communicating with slave base station 401L).

Slave base station 402 transmits the transmission data transmitted from slave base station 401L to slave base station 403 being a base station located downstream of slave base station 402. Slave base station 402 distributes the transmission data transmitted from slave base station 401L to a terminal allowing slave base station 402 to accept transmission data (for example, terminal capable of communicating with slave base station 402).

Slave base station 403 receives and acquires transmission data transmitted from slave base station 402. Slave base station 403 distributes the transmission data transmitted from slave base station 402 to a terminal allowing slave base station 403 to accept transmission data (for example, terminal capable of communicating with slave base station 403).

Slave base station 401R transmits the transmission data transmitted from master base station 10A to slave base station 404 being a base station located downstream of slave base station 401R. Slave base station 401R distributes the transmission data transmitted from master base station 10A to a terminal allowing slave base station 401R to accept transmission data (for example, terminal capable of communicating with slave base station 401R).

Slave base station 404 receives and acquires transmission data transmitted from slave base station 401R. Slave base station 404 distributes the transmission data transmitted from slave base station 401R to a terminal allowing slave base station 404 to accept transmission data (for example, terminal capable of communicating with slave base station 404). As described above, the operation procedure when transmission data is transmitted from the base station (that is, master base station 10A) on the most upstream in multi-hop to the base station located downstream in accordance with each of relay routes Tr3 and Tr4, by using the downlink is periodically repeated.

Here, it is assumed, for example, that a problem occurs in slave base station 402 due to some causes.

Slave base station 401L determines that the problem occurs in slave base station 402, based on the detection that the control signal from slave base station 402 is not received (S21). Slave base station 401L generates a problem detection signal including identification information of slave base station 402 and performs a notification to detect that the problem occurs, by transmitting the problem detection signal to master base station 10A located upstream (S22). Slave base station 403 determines that a problem occurs in slave base station 402, based on the detection that the control signal from slave base station 402 is not received (S23). If slave base station 403 determines that the problem occurs in slave base station 402, slave base station 403 starts a radio communication with slave base station 404 through dielectric waveguide DH6 which is not used in the normal time. Slave base station 403 generates a problem detection signal including identification information of slave base station 402 and performs a notification to detect that the problem occurs, by transmitting the problem detection signal to slave base station 404 (S24). If slave base station 404 receives the problem detection signal transmitted from slave base station 403, slave base station 404 transfers a problem detection notification by transmitting the received problem detection signal to slave base station 401R located upstream (S25). If slave base station 401R receives the problem detection signal transmitted from slave base station 403, slave base station 401R transfers a problem detection notification by transmitting the received problem detection signal to master base station 10A located upstream (S26). Thus, master base station 10A can correctly determine that the problem occurs in slave base station 402 (S27).

If master base station 10A determines that the problem occurs in slave base station 402, as illustrated in FIG. 11, master base station 10A changes logical tree LGT3 (that is, multi-hop relay routes Tr3 and Tr4) to logical tree LGT4 (that is, multi-hop relay routes Tr5 and Tr6) so as to avoid using of slave base station 402 in which the problem occurs (S28).

Master base station 10A transmits information regarding relay routes Tr5 and Tr6 after change to slave base stations 401L and 401R located downstream of master base station 10A (S29). Master base station 10A notifies administrator terminal TL1 held by the user of a message including a message indicating that the problem occurs in slave base station 402 and a message of urging recovery of slave base station 402 (S30).

If slave base station 401R receives the information regarding relay routes Tr5 and Tr6, which is transmitted from master base station 10A, slave base station 401R updates the information by registering the received information in memory 27 in slave base station 401R, and transfers the information regarding relay routes Tr5 and Tr6 to slave base station 404 located downstream of slave base station 401R (S31). If slave base station 404 receives the information regarding relay routes Tr5 and Tr6, which is transmitted from slave base station 401R, slave base station 404 updates the information by registering the received information in memory 27 in slave base station 404, and transfers the information regarding relay routes Tr5 and Tr6 to slave base station 403 located downstream of slave base station 404 (S32). If slave base station 403 receives the information regarding relay routes Tr5 and Tr6, which is transmitted from slave base station 404, slave base station 403 updates the information by registering the received information in memory 27.

Thus, after the problem occurs in slave base station 402, master base station 10A and slave base stations 401L, 401R, 404, and 403 can perform multi-hop radio communication with each other based on the information regarding relay routes Tr5 and Tr6 after the change.

That is, master base station 10A receives and accepts transmission data transmitted from at least one terminal (for example, administrator terminal TL1) in room RM1 in which master base station 10A is disposed or in a communication area with master base station 10A (S1C). Similarly, slave base stations 401L, 403, 404, and 401R receive and accept transmission data transmitted from at least one terminal in room RM6 in which the own station is disposed, in living room RM3, in dining room RM4, in room RM1, or in a communication area with the own station (S1C).

Slave base station 403 being a base station positioned on the most downstream in relay route Tr6 transmits transmission data accepted by slave base station 403 to slave base station 404 being a base station positioned upstream of slave base station 403 (S41). Slave base station 404 associates the transmission data accepted by slave base station 404 in Step S1C with the transmission data transmitted from slave base station 403 in Step S41. Slave base station 404 transmits the result of the association to slave base station 401R being a base station positioned upstream of slave base station 404 (S42). Slave base station 401R associates the transmission data accepted by slave base station 401R in Step S1C with the transmission data transmitted from slave base station 404 in Step S42. Slave base station 401R transmits the result of the association to master base station 10A being a base station positioned upstream of slave base station 401R (S43).

Slave base station 401L being a base station positioned on the most downstream in relay route Tr5 transmits transmission data accepted by slave base station 401L to master base station 10A being a base station positioned upstream of slave base station 401L (S44).

Master base station 10A associates the transmission data accepted by master base station 10A in Step S1C, the transmission data transmitted from slave base station 401R in Step S43, and the transmission data transmitted from slave base station 401L in Step S44 with each other. Master base station 10A transmits the result of the association to external base station 80 through antenna Att (S45). The processes of Step S1C and Step S41 to Step S45 are periodically repeated by the user who recognizes reception of the message from master base station 10A in Step S30, until slave base station 402 is recovered.

Here, although not illustrated, differing from FIG. 13, an operation procedure when transmission data is transmitted from the base station (that is, master base station 10A) on the most upstream in multi-hop to the base station located downstream in accordance with each of relay routes Tr5 and Tr6, by using a downlink will be described.

External base station 80 receives transmission data (for example, response to a request from a terminal in private house HME) transmitted from at least one of application servers APS1, APS2, and APS3 and transfers (that is, relays) the transmission data to master base station 10A.

Master base station 10A being a base station positioned on the most upstream in multi-hop transmits transmission data transmitted from external base station 80, to slave base stations 401L and 401R being base stations positioned located downstream of master base station 10A. Master base station 10A distributes the transmission data transmitted from external base station 80 to a terminal allowing master base station 10A to accept transmission data (for example, terminal capable of communicating with master base station 10).

Slave base station 401L receives and acquires transmission data transmitted from master base station 10A. Slave base station 401L distributes the transmission data transmitted from master base station 10A to a terminal allowing slave base station 401L to accept transmission data (for example, terminal capable of communicating with slave base station 401L).

Slave base station 401R transmits the transmission data transmitted from master base station 10A to slave base station 404 being a base station located downstream of slave base station 401R. Slave base station 401R distributes the transmission data transmitted from master base station 10A to a terminal allowing slave base station 401R to accept transmission data (for example, terminal capable of communicating with slave base station 401R).

Slave base station 404 transmits the transmission data transmitted from slave base station 401R to slave base station 403 being a base station located downstream of slave base station 404. Slave base station 404 distributes the transmission data transmitted from slave base station 401R to a terminal allowing slave base station 404 to accept transmission data (for example, terminal capable of communicating with slave base station 404).

Slave base station 403 receives and acquires transmission data transmitted from slave base station 404. Slave base station 403 distributes the transmission data transmitted from slave base station 402 to a terminal allowing slave base station 403 to accept transmission data (for example, terminal capable of communicating with slave base station 403). As described above, the operation procedure when transmission data is transmitted from the base station (that is, master base station 10A) on the most upstream in multi-hop to the base station located downstream in accordance with each of relay routes Tr5 and Tr6, by using the downlink is periodically repeated.

With the above descriptions, in in-facility transmission system 100B in Exemplary Embodiment 3, in the normal time in which a problem does not occur in any slave base station, master base station 10A and five slave base stations 401L, 402, 403, 404, and 401R can be connected to each other in a ring shape through dielectric waveguides DH1, DH2, DH5, DH6, DH7, and DH4 different from each other in radio. When a problem occurs in any slave base station (for example, slave base station 402), master base station 10A determines slave base station 402 in which the problem occurs, based on detection that master base station 10A or slave base station 401L or 403 that performs a radio communication with slave base station 402 before the occurrence of the problem does not receive the control signal from slave base station 402.

Thus, even in a case where the problem occurs in any slave base station (for example, slave base station 402), master base station 10A can accurately and rapidly detect the slave base station in which the problem occurs.

Master base station 10A holds the information regarding the relay path of transmission data in memory 17 and changes the information regarding the relay path of transmission data based on the determination of the slave base station (for example, slave base station 402) in which the problem occurs.

Thus, master base station 10A can avoid using of slave base station 402 until the slave base station (for example, slave base station 402) in which the problem has occurred is recovered, and favorably perform multi-hop radio communications between master base station 10A and the four slave base stations 401L, 401R, 404, and 403 in accordance with the two relay routes Tr5 and Tr6.

Master base station 10A notifies administrator terminal TL1 in room RM5 in which master base station 10A is disposed, of a message of urging recovery of slave base station 402 based on the determination of any slave base station (for example, slave base station 402) in which the problem occurs.

Thus, the user holding administrator terminal TL1 views the message transmitted from master base station 10A, and thus can accurately recognize that the problem occurs in slave base station 402, and can perform a recovery operation quickly. Thus, in in-facility transmission system 100B, slave base station 402 is recovered quickly.

Hitherto, the various exemplary embodiments are described with reference to the drawings, but the disclosure is not limited to the above examples. It will be apparent to those skilled in the art that various changes and modifications can be made within the scope of the claims, and these are within the technical scope of the disclosure. The constituent components in the exemplary embodiments may be randomly combined in a range without departing from the gist of the invention.

### INDUSTRIAL APPLICABILITY

The disclosure is useful for the in-facility transmission system, the in-facility transmission method, and the base station in which it is possible to secure desired communication quality in relay for data transmission between base stations and to realize a stable radio communication, in a facility in which the base stations are provided in closed spaces different from each other.

### REFERENCE MARKS IN THE DRAWINGS

10, 10A MASTER BASE STATION

11, 15, 41, 44, 46 SLAVE BASE STATION CONNECTOR

12, 22, 42, 45 RELAY CONTROLLER

13 EXTERNAL BASE STATION CONNECTOR

14, 24 TERMINAL ACCEPTOR

17, 27 MEMORY

21 DOWNSTREAM BASE STATION CONNECTOR

23 UPSTREAM BASE STATION CONNECTOR

43 MASTER BASE STATION CONNECTOR

80 EXTERNAL BASE STATION

100, 100A, 100B IN-FACILITY TRANSMISSION SYSTEM

201, 202, 203, 401L, 401R, 402, 403, 404 SLAVE BASE STATION

APS1, APS2, APS3 APPLICATION SERVER

CNW CORE NETWORK

DH1, DH2, DH3, DH4, DHS, DH6, DH7 DIELECTRIC WAVEGUIDE

TL1 ADMINISTRATOR TERMINAL

TL2 RECORDER

TL3 SURVEILLANCE CAMERA

1.-15. (canceled)

16. An in-facility transmission system disposed in a facility with a plurality of closed spaces, the system comprising:
a master base station that is disposed in a first closed space and is connected to an antenna provided outside the facility to perform a radio communication with an external base station through the antenna;
a first slave base station that is disposed in a second closed space different from the first closed space and performs a radio communication in a high frequency band used in a 5G radio network, with the master base station; and
a first radio waveguide that is a dielectric waveguide that is formed of a member capable of reducing a propagation loss of a radio wave in the radio communication in the high frequency band and propagates the radio wave between the master base station disposed in the first closed space and the first slave base station disposed in the second closed space,
wherein the first slave base station transmits received transmission data to the master base station through the first radio waveguide, and
the master base station transmits the transmission data to the external base station.

17. The in-facility transmission system of claim 16, further comprising:
a second slave base station that is disposed in a third closed space among the plurality of closed spaces and performs a radio communication in the high frequency band used in the 5G radio network, with the first slave base station; and
a second radio waveguide that is a dielectric waveguide that is formed of a member capable of reducing the propagation loss of the radio wave in the radio communication in the high frequency band and propagates the radio wave between the first slave base station disposed in the second closed space and the second slave base station disposed in the third closed space,
wherein the second slave base station transmits received transmission data to the first slave base station through the second radio waveguide.

18. The in-facility transmission system of claim 17,
wherein the first slave base station transmits transmission data accepted by the first slave base station and the transmission data transmitted from the second slave base station, to the master base station as a relay destination.

19. The in-facility transmission system of claim 17,
wherein the master base station receives transmission data transmitted from the external base station and transmits the received transmission data to the first slave base station as a relay destination, and
the first slave base station transmits the transmission data transmitted from the master base station to the second slave base station as a relay destination.

20. The in-facility transmission system of claim 17, further comprising:
a third slave base station that is disposed in a fourth closed space among the plurality of closed spaces and performs a radio communication in the high frequency band used in the 5G radio network, with the master base station;
a third radio waveguide that is a dielectric waveguide that is formed of a member capable of reducing the propagation loss of the radio wave in the radio communication in the high frequency band and propagates the radio wave between the master base station disposed in the first closed space and the third slave base station disposed in the fourth closed space; and
a fourth radio waveguide that is a dielectric waveguide that is formed of a member capable of reducing the propagation loss of the radio wave in the radio communication in the high frequency band and propagates the radio wave between the second slave base station disposed in the third closed space and the third slave base station disposed in the fourth closed space,
wherein the third slave base station transmits received transmission data to the master base station through the third radio waveguide or to the second slave base station through the fourth radio waveguide.

21. The in-facility transmission system of claim 20,
wherein the master base station includes a memory configured to hold information regarding a relay path of transmission data and directly or indirectly notifies each slave base station of the information regarding the relay path of the transmission data, and
each slave base station transmits transmission data accepted by the own station or transmits the transmission data accepted by the own station and transmission data transmitted from a slave base station located downstream of the own station, to the master base station or a slave base station located upstream of the own station, as a relay destination, based on the information regarding the relay path of the transmission data, of which the notification is received from the master base station.

22. The in-facility transmission system of claim 20,
wherein the master base station includes a memory configured to hold information regarding a relay path of transmission data and directly or indirectly notifies each slave base station of the information regarding the relay path of the transmission data,
the master base station receives transmission data transmitted from the external base station and transmits the transmission data to the first slave base station and the third slave base station as a relay destination, based on the information regarding the relay path, and
the first slave base station transmits the transmission data transmitted from the master base station to the second slave base station as a relay destination, based on the information regarding the relay path of the transmission data, of which the notification is received from the master base station.

23. The in-facility transmission system of claim 20,
wherein, when a problem occurs in any slave base station, the master base station determines the slave base station in which the problem occurs, based on a detection that a control signal from the slave base station is not received, by the master base station which has performed the radio communication with the any slave base station before the problem occurs, or the slave base station.

24. The in-facility transmission system of claim 23,
wherein the master base station includes a memory configured to hold information regarding a relay path of transmission data and changes the information regarding the relay path of the transmission data based on the determination of the any slave base station in which the problem occurs.

25. The in-facility transmission system of claim 23,
wherein the master base station notifies an administrator terminal of a message for urging recovery of the any slave base station based on the determination of the any slave base station in which the problem occurs.

26. An in-facility transmission method using an in-facility transmission system disposed in a facility with a plurality of closed spaces,
wherein base stations disposed in any closed spaces are disposed to connect the plurality of closed spaces to each other and perform radio communications in a high frequency band used in a 5G radio network, with another base station disposed in a closed space different from the closed space for the own station, through a dielectric waveguide formed of a member capable of reducing a propagation loss of a radio wave in the radio communication in the high frequency band, and
at least one of the base stations is connected to an antenna provided outside the facility and performs a radio communication with an external base station through the antenna.

27. A base station used in an in-facility transmission system disposed in a facility with a plurality of closed spaces,
wherein the base station is disposed in a first closed space among the plurality of closed spaces,
the base station comprises
a first communicator that is connected to an antenna provided outside the facility and performs a radio communication with an external base station through the antenna, and
a second communicator that performs a radio communication in a high frequency band used in a 5G radio network, with a slave base station disposed in a second closed space different from the first closed space in which the own station is disposed,
the base station performs the radio communication in the high frequency band with the slave base station by the second communicator through a dielectric waveguide that is formed of a member capable of reducing a propagation loss of a radio wave in the radio communication in the high frequency band and propagates the radio wave between the own station disposed in the first closed space and the slave base station disposed in the second closed space, and
the base station performs the radio communication with the external base station by the first communicator.

28. A base station used in an in-facility transmission system disposed in a facility with a plurality of closed spaces,
wherein the base station is disposed in a first closed space among the plurality of closed spaces,
the base station comprises a communicator that performs a radio communication in a high frequency band used in a 5G radio network, with a master base station that is disposed in a second closed space different from the first closed space in which the base station is disposed, is connected to an antenna provided outside the facility, and performs a radio communication with an external base station through the antenna, and
the base station performs the radio communication in the high frequency band, with the master base station by the communicator through a dielectric waveguide that is formed of a member capable of reducing a propagation loss of a radio wave in the radio communication in the high frequency band and propagates the radio wave between the own station disposed in the first closed space and the master base station disposed in the second closed space.

29. A base station used in an in-facility transmission system in a facility in which a plurality of closed spaces are provided, and a plurality of base stations respectively disposed in the plurality of closed spaces are connected to each other in radio,
wherein the base station is disposed in one closed space among the plurality of closed spaces,
the base station comprises
a first communicator that performs a radio communication in a high frequency band used in a 5G radio network, with a master base station or a slave base station disposed in a closed space located upstream of the closed space in which the own station is disposed, through a first dielectric waveguide that is formed of a member capable of reducing a propagation loss of a radio wave in the radio communication in the high frequency band and propagates the radio wave between the base stations disposed in the plurality of closed spaces,
a second communicator that performs a radio communication in a high frequency band used in a 5G radio network, with a slave base station disposed in a closed space located downstream of the closed space in which the own station is disposed, through a second dielectric waveguide that is formed of a member capable of reducing a propagation loss of a radio wave in the radio communication in the high frequency band and propagates the radio wave between the base stations disposed in the plurality of closed spaces, and
a terminal acceptor that receives transmission data transmitted from a terminal connected to the own station, and
the base station transmits the transmission data received by the terminal acceptor and transmission data received by the second communicator to the master base station or the slave base station through the first communicator.

30. The base station of claim 29,
wherein the base station transmits transmission data received by the first communicator to the slave base station through the second communicator and to the terminal through the terminal acceptor.
